(19) United States
(12) Patent Application Publication
(10) Pub. No.: US 2026/0174607 A1
(43) Pub. Date: Jun. 25, 2026

(54) Manual Loading Devices And Systems For Use With Patient Transport Apparatuses

(71) Applicant: Stryker Corporation, Portage, MI (US)

(72) Inventors: Sean Derrick, Kalamazoo, MI (US); Patrick Grossman, Grand Haven, MI (US); Sashank Manohar, Portage, MI (US); Brian J. Tessmer, Mattawan, MI (US)

(73) Assignee: Stryker Corporation, Portage, MI (US)

(21) Appl. No.: 19/408,539

(22) Filed: Dec. 4, 2025

Related U.S. Application Data
(60) Provisional application No. 63/737,858, filed on Dec. 23, 2024.

(51) Int. Cl. A61G 3/06; A61G 3/02; A61G 3/08; A61G 5/06

(52) U.S. Cl. CPC A61G 3/062; A61G 3/0245; A61G 3/0281; A61G 3/0808; A61G 5/061; A61G 5/066

(57) ABSTRACT

A system including a patient transport apparatus having and a track assembly with a belt for engaging stairs, and a loading device configured to engage the patient transport apparatus for loading and unloading from a transport vehicle. The loading device includes a stage, a receiver arranged for translational movement relative to the stage between a lowered position and a raised position, a dock operatively attached to the receiver for supporting the patient transport apparatus, and an elevating mechanism operably coupled between the stage and the receiver, the elevating mechanism being operable between a first mode defined with a first lifting force acting on the receiver, and a second mode defined with a second lifting force acting on the receiver to for moving the receiver and the patient transport apparatus loaded onto the dock into a secured configuration for transit with the transport vehicle.

### CROSS-REFERENCE TO RELATED APPLICATION(S)

This patent application claims priority to and all the benefits of U.S. Provisional Patent Application No. 63/737,858 filed on Dec. 23, 2024, the disclosure of which is hereby incorporated by reference in its entirety.

### BACKGROUND

In various environments, persons with limited mobility may have difficulty traversing stairs without assistance. In certain emergency situations, traversing stairs may be the only viable option for exiting a building. Here, in order for a caregiver to transport a patient along stairs in a safe and controlled manner, a stair chair or evacuation chair may be utilized to facilitate safe stair traversal. Stair chairs are adapted to transport seated patients either up or down flights of stairs, with two caregivers typically supporting, stabilizing, or otherwise carrying the stair chair with the patient supported thereon. The stair chair may be powered and include a battery and an electric motor, which further aids the caregiver when transporting heavy patients or on steeply inclined stairs.

The stair chair is generally transported inside an ambulance to the location of a patient. Within the ambulance, space is generally limited. Tightly packing all of the tools and supplies carried on an ambulance negatively impacts the time required to retrieve an item. An ambulance may have one or more exterior storage compartments that can be used to efficiently store that are only needed once the ambulance has arrived at the location of the patient.

A loading system that overcomes the difficulty of loading and unloading a stair chair in a storage compartment with limited space is desirable.

### SUMMARY

The present disclosure provides a loading device for use in loading and unloading a patient transport apparatus from a transport vehicle, the patient transport apparatus including a support structure operable in a stowed configuration and having a track assembly with a movable belt for engaging stairs, the loading device may include: a mount configured for mounting to the transport vehicle; a stage operatively attached to the mount; a receiver arranged for translational movement relative to the stage between a lowered position and a raised position; a dock operatively attached to the receiver for supporting the patient transport apparatus; and an elevating mechanism operably coupled between the stage and the receiver, the elevating mechanism being operable between: a first mode defined with a first lifting force acting on the receiver to move the receiver from the lowered position towards the raised position, and a second mode defined with a second lifting force, greater than the first lifting force, acting on the receiver to move the receiver from the lowered position towards the raised position for moving the receiver and the patient transport apparatus loaded onto the dock into a secured configuration for transit with the transport vehicle.

The present disclosure also provides a system for use with a transport vehicle, the system may include: a patient transport apparatus including: a support structure having a seat section and being movable between a stowed configuration and one or more patient transport configurations, and a track assembly operatively attached to the support structure and including a movable belt for engaging stairs in one of the one or more patient transport configurations; and a loading device configured to engage the patient transport apparatus in the stowed configuration for loading and unloading from the transport vehicle, the loading device including: a mount configured for mounting to the transport vehicle, a stage operatively attached to the mount, a receiver arranged for translational movement relative to the stage between a lowered position and a raised position, a dock operatively attached to the receiver for supporting the patient transport apparatus, and an elevating mechanism operably coupled between the stage and the receiver, the elevating mechanism being operable between: a first mode defined with a first lifting force acting on the receiver to move the receiver from the lowered position towards the raised position, and a second mode defined with a second lifting force, greater than the first lifting force, acting on the receiver to move the receiver from the lowered position towards the raised position for moving the receiver and the patient transport apparatus loaded onto the dock into a secured configuration for transit with the transport vehicle.

### BRIEF DESCRIPTION OF THE DRAWINGS

Advantages of the present disclosure will be readily appreciated as the same becomes better understood by reference to the following detailed description when considered in connection with the accompanying drawings.

FIG. 1A is an environmental view of a system including a patient transport apparatus shown adjacent to a transport vehicle having a loading device for loading the patient transport apparatus into a first cargo area, the loading device shown having a receiver arranged in a raised position, and a locking mechanism arranged in a retained mode for operating an elevating mechanism of the loading device in a first mode.

FIG. 1B is another environmental view of the system of FIG. 1A, shown with the receiver of the loading device arranged in a lowered position.

FIG. 1C is another environmental view of the system of FIGS. 1A-1B, shown with the patient transport apparatus retained to the loading device in the lowered position.

FIG. 1D is another environmental view of the system of FIGS. 1A-1C, shown with the patient transport apparatus retained to the loading device in the lowered position, and with the locking mechanism arranged in a released mode for operating the elevating mechanism in a second mode.

FIG. 1E is another environmental view of the system of FIGS. 1A-1D, shown with the patient transport retained to the loading device and with the loading device arranged in a raised position.

FIG. 2A is an environmental view of another version of the system of FIG. 1A, shown with the transport vehicle having a loading device arranged in a secured configuration in a raised position retracted into a second cargo area of the transport vehicle, with the locking mechanism arranged in the retained mode for operating the elevating mechanism in the first mode.

FIG. 2B is another environmental view of the system of FIG. 2A, shown with the loading device arranged in an intermediate configuration extended out of the transport vehicle and in the raised position.

FIG. 2C is another environmental view of the system of FIG. 2B, shown with the loading device arranged in an access configuration extended out of the transport vehicle and in the lowered position for receiving the patient transport apparatus.

FIG. 3A is another environmental view of the system of FIG. 2C, shown with the patient transport apparatus loaded and retained to the loading device in the lowered position and extended out of the transport vehicle.

FIG. 3B is another environmental view of the system of FIG. 3A, shown with the patient transport apparatus retained to the loading device in the lowered position, and with the locking mechanism arranged in the released mode for operating the elevating mechanism in the second mode.

FIG. 3C is another environmental view of the system of FIG. 3B, shown with the patient transport apparatus loaded and retained to the loading device in the raised position and extended out of the transport vehicle.

FIG. 3D is another environmental view of the system of FIG. 3C, shown with the patient transport apparatus loaded and retained to the loading device in the raised position and retracted into the second cargo area of the transport vehicle.

FIG. 4 is a front perspective view of the patient transport apparatus of the system of FIGS. 1A-3D, shown arranged in a stair configuration for supporting a patient for transport along stairs, and shown with a track assembly disposed in a deployed position, and with a handle assembly disposed in an extended position.

FIG. 5 is another front perspective view of the patient transport apparatus of FIG. 4, shown arranged in a chair configuration for supporting a patient for transport along a floor surface, and shown with a track assembly disposed in a retracted position, and with a handle assembly disposed in a collapsed position.

FIG. 6 is a rear perspective view of the patient transport apparatus of FIGS. 4 and 5, shown arranged in the stair configuration as depicted in FIG. 4, and shown having an extension lock mechanism, a folding lock mechanism, and a deployment lock mechanism.

FIG. 7 is a partial schematic view of a control system of the patient transport apparatus of FIGS. 4-6, shown with a controller disposed in communication with a battery, a user interface, and a drive system.

FIG. 8 is a right-side plan view of the patient transport apparatus of FIGS. 4-7, shown arranged in a stowed configuration maintained by the folding lock mechanism.

FIG. 9A is another right-side plan view of the patient transport apparatus arranged in the chair configuration and with the handle assembly in a collapsed position.

FIG. 9B is another right-side plan view of the patient transport apparatus arranged in the stair configuration and with the handle assembly in an intermediate position.

FIG. 9C is another right-side plan view of the patient transport apparatus arranged in the stair configuration and with the handle assembly in an extended position.

FIG. 10A is a partial rear perspective view of the patient transport apparatus of FIGS. 4-9C, shown arranged in the stowed configuration as depicted in FIG. 3B, with the deployment lock mechanism shown retaining the track assembly in the retracted position.

FIG. 10B is another partial rear perspective view of the patient transport apparatus of FIG. 10A, shown arranged in the stowed configuration, with the deployment lock mechanism shown retaining the track assembly in the deployed position.

FIG. 11 is a rear view of the back side of the patient transport apparatus of FIG. 3B depicting the user interface.

FIG. 12A is a right-side plan view of the patient transport apparatus of FIG. 3B, shown supporting a patient in the chair configuration on a floor surface adjacent to stairs, and shown with a first caregiver engaging a pivoting handle assembly.

FIG. 12B is another right-side plan view of the patient transport apparatus of FIG. 12A, shown with the first caregiver having engaged the deployment lock mechanism to move the track assembly out of the retracted position and a second caregiver engaging a front handle assembly in an extended position.

FIG. 12C is another right-side plan view of the patient transport apparatus of FIG. 12B, shown having moved towards the stairs for descent while supported by the first and second caregivers.

FIG. 12D is another right-side plan view of the patient transport apparatus of FIG. 12C, shown having moved initially down the stairs for descent to bring a belt of the track assembly into contact with the stairs while still supported by the first and second caregivers.

FIG. 12E is another right-side plan view of the patient transport apparatus of FIG. 12D, shown with the belt of the track assembly in contact with the stairs while still supported by the first and second caregivers.

FIG. 12F is another right-side plan view of the patient transport apparatus of FIG. 12E, shown with the belt of the track assembly in contact with the stairs while still supported by the first and second caregivers.

FIG. 13 is a perspective view of the loading device of the system depicted in FIGS. 2A-3D, shown having a stage arranged in a lowered position and a second stage arranged in an extended position.

FIG. 14 is a perspective view of the loading device of the system depicted in FIGS. 1A-1D, shown having a stage arranged in a raised position.

FIG. 15 is a partial, exploded perspective view of the loading device of FIG. 14, shown having a receiver, a retainer, a dock, and an elevating mechanism.

FIG. 16 is a front-side plan view of the loading device of the system of FIGS. 14-15.

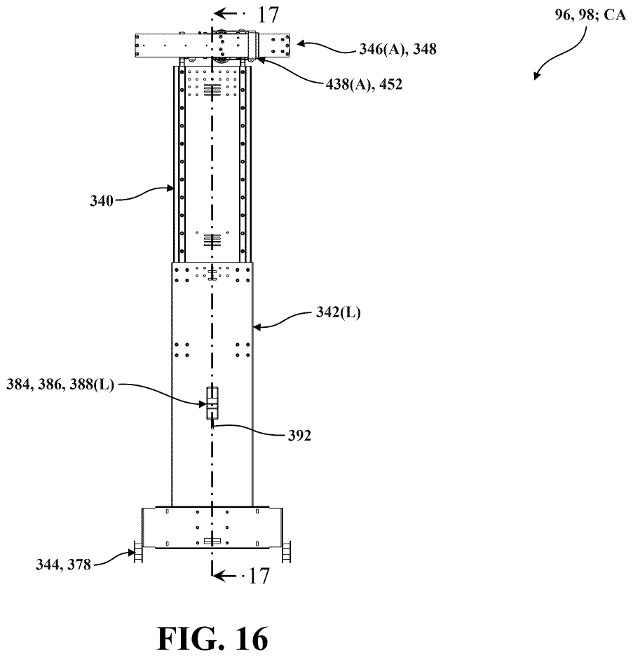

FIG. 17A is a sectional view depicting the loading device of the system taken along line 17-17 in FIG. 16, shown with the retainer arranged in a released position.

FIG. 17B is another sectional view of the system of FIG. 17A, shown with the retainer of the loading device arranged in the released position adjacent to the patient transport apparatus.

FIG. 17C is another sectional view of the system of FIG. 17B, shown with the retainer of the loading device arranged in a retained position engaging the patient transport apparatus.

FIG. 18 is a perspective view of the elevating mechanism of the loading device of FIG. 15, shown having a loading subassembly and an interface coupling.

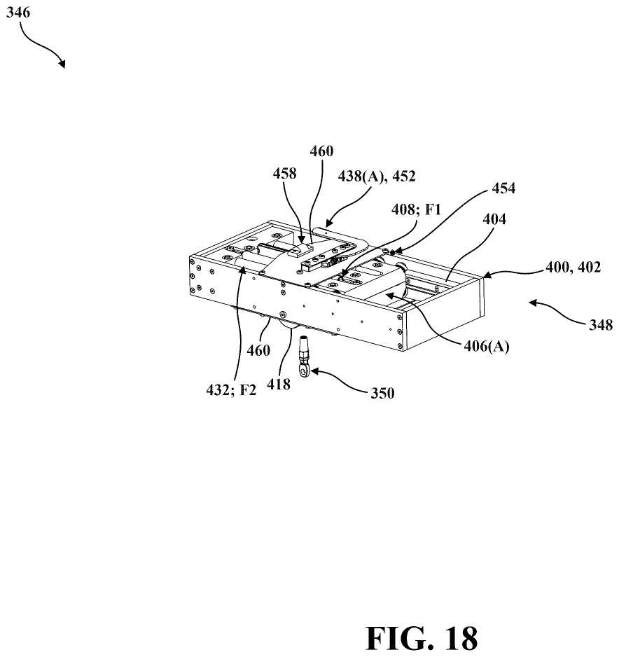

FIG. 19 is a partially-exploded perspective view of the loading subassembly of the elevating mechanism of FIG. 18, shown having a loading frame, a carriage, a lift actuator, a driver interface, a load actuator, and a locking mechanism.

FIG. 20 is a perspective view of the locking mechanism of the loading subassembly of FIG. 19.

FIG. 21 is an exploded perspective view of the locking mechanism of FIG. 20.

FIG. 22A is a partial perspective view of the elevating mechanism of FIGS. 18-20, shown with a flexible tension element extending between the interface coupling and an end mount coupled to the loading frame, the flexible tension element routed around frame pullies operatively attached to the loading frame and carriage pullies operatively attached to the carriage, and shown with the carriage arranged in a carriage position corresponding to the raised position of the receiver.

FIG. 22B is another partial perspective view of the elevating mechanism of FIG. 22A, shown with the carriage arranged in a carriage position corresponding to the lowered position of the receiver.

FIG. 23A is another partial perspective view of the elevating mechanism of FIG. 22A, shown with portions removed and with the carriage depicted in phantom to illustrate routing of the flexible tension element.

FIG. 23B is another partial perspective view of the elevating mechanism of FIG. 22B, shown with portions removed and with the carriage depicted in phantom to illustrate routing of the flexible tension element.

FIG. 24 is a front-side plan view of the loading subassembly of the elevating mechanism of FIGS. 15-19 and 21-23B.

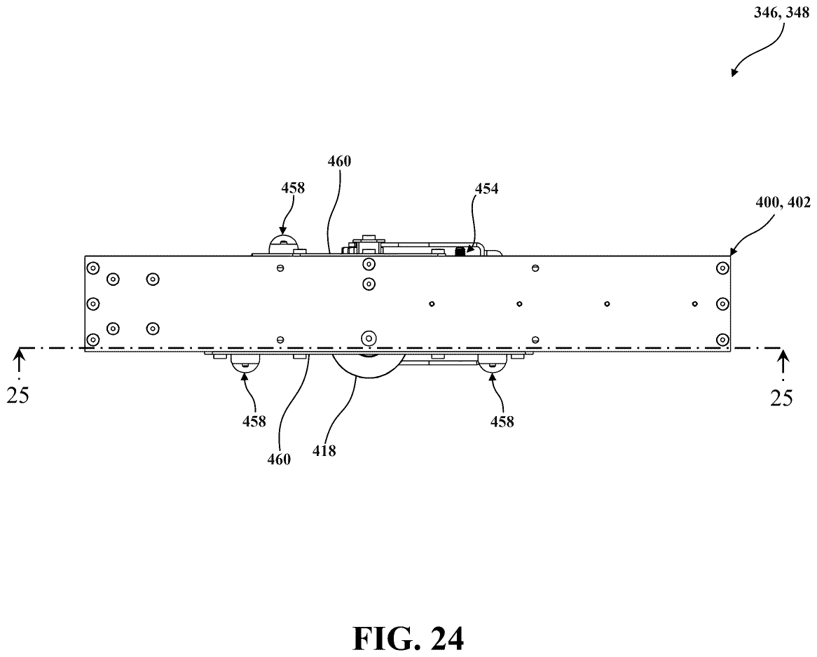

FIG. 25A is a sectional view depicting the loading subassembly taken along line 17-17 in FIG. 24, shown with the locking mechanism arranged in the released mode.

FIG. 25B is another sectional view of the loading subassembly of FIG. 25A, shown with the locking mechanism arranged in the retained mode.

FIG. 26 is a perspective view of the elevating mechanism of FIGS. 15-19 and 21-25.

FIG. 27A is another perspective view of the elevating mechanism of FIG. 26, shown with portions of the loading subassembly removed for illustrative purposes, and shown with the carriage arranged in the second carriage position corresponding to the raised position of the receiver, and with the locking mechanism arranged in the retained mode to maintain the driver interface in a first interface position spaced from the carriage for operating the elevating mechanism in the first mode.

FIG. 27B is another perspective view of the elevating mechanism of FIG. 27A, shown with the carriage arranged in the first carriage position corresponding to the lowered position of the receiver, and with the locking mechanism arranged in the retained mode to maintain the driver interface in the first interface position for operating the elevating mechanism in the first mode.

FIG. 27C is another perspective view of the elevating mechanism of FIG. 27B, shown with the carriage arranged in the first carriage position corresponding to the lowered position of the receiver, and with the locking mechanism arranged in the released mode to permit movement of the driver interface for operating the elevating mechanism in the second mode.

FIG. 27D is another perspective view of the elevating mechanism of FIG. 27C, shown with the carriage arranged in an intermediate carriage position corresponding to an intermediate position of the receiver, and with the locking mechanism arranged in the released mode to permit movement of the driver interface for operating the elevating mechanism in the second mode, the driver interface shown abutting the carriage.

FIG. 27E is another perspective view of the elevating mechanism of FIG. 27D, shown with the carriage arranged in the second carriage position corresponding to the raised position of the receiver, and with the locking mechanism arranged in the released mode to permit movement of the driver interface for operating the elevating mechanism in the second mode, the driver interface shown arranged in a second interface position abutting the carriage.

FIG. 27F is another perspective view of the elevating mechanism of FIG. 27E, shown with the carriage arranged in the second carriage position corresponding to the raised position of the receiver, and with the locking mechanism arranged in the retained mode to inhibit movement of the driver interface and the carriage, the driver interface shown arranged in the second interface position abutting the carriage.

### DETAILED DESCRIPTION

Referring now to the drawings, wherein like numerals indicate like parts throughout the several views, the present disclosure is directed toward a system 96 (also referred to herein as a “loading system”) with a loading device 98 to facilitate loading and unloading a patient transport apparatus 100 relative to a transport vehicle VEH (e.g., an ambulance) for storage and transport, as described in greater detail below.

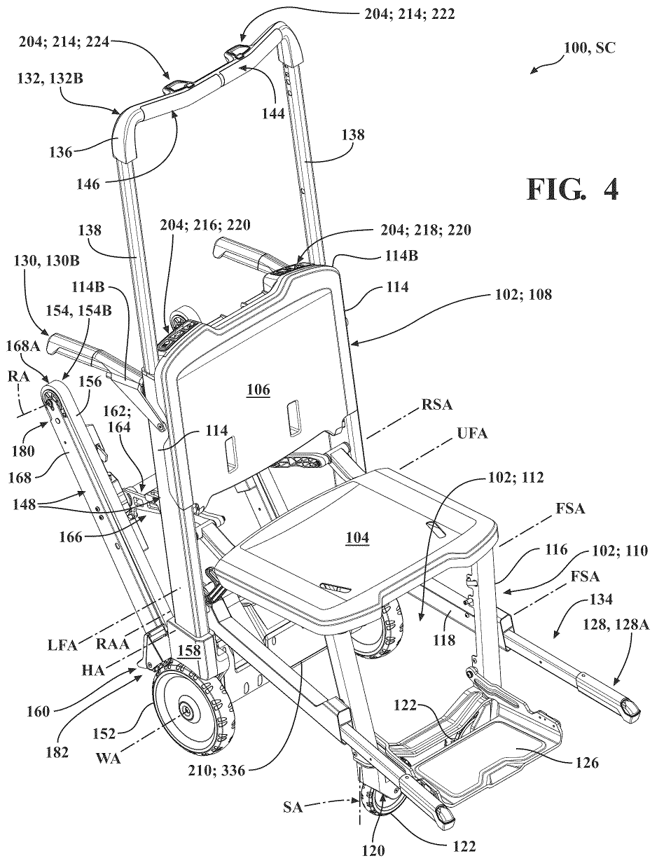

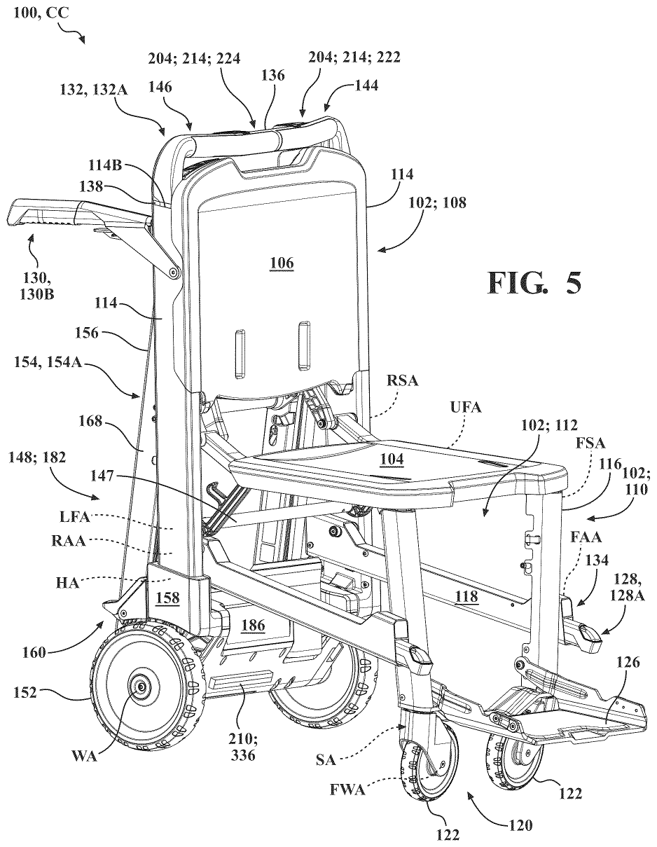

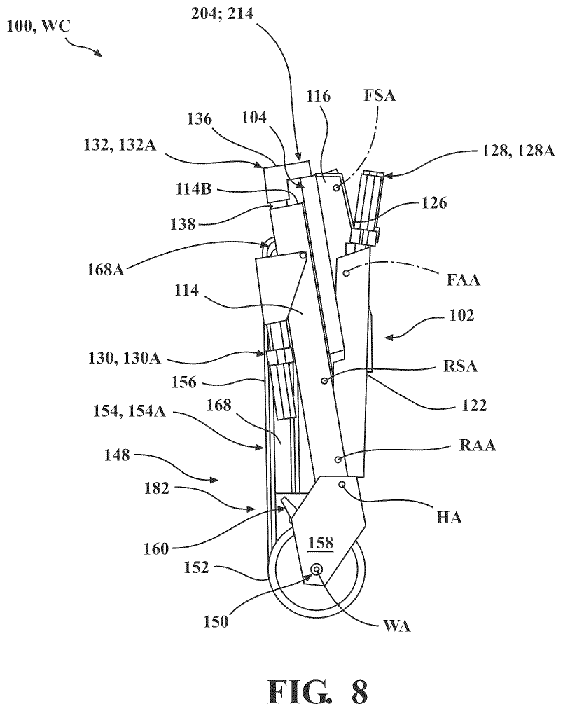

The patient transport apparatus 100 is realized as a “stair chair”, which can be operated in a chair configuration CC (see FIG. 5) to transport the patient across ground or floor surfaces FS (e.g., pavement, hallways, and the like), a stair configuration SC (see FIG. 4) to transport the patient along stairs ST, and a stowed (or folded) configuration FC (see FIG. 8) when not being utilized to transport patients. As will be appreciated from the subsequent description below, the patient transport apparatus 100 may be stored or otherwise transported in the transport vehicle VEH in the stowed configuration FC.

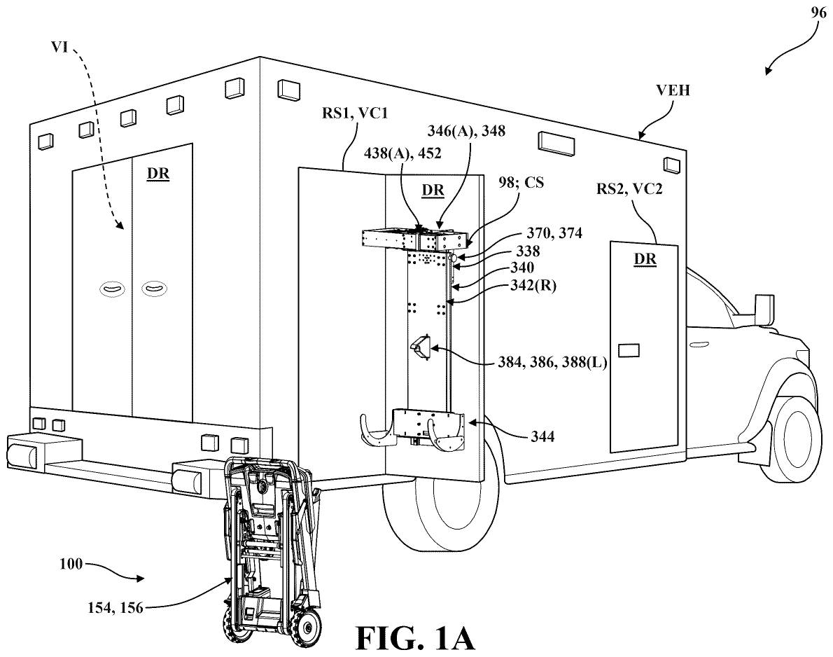

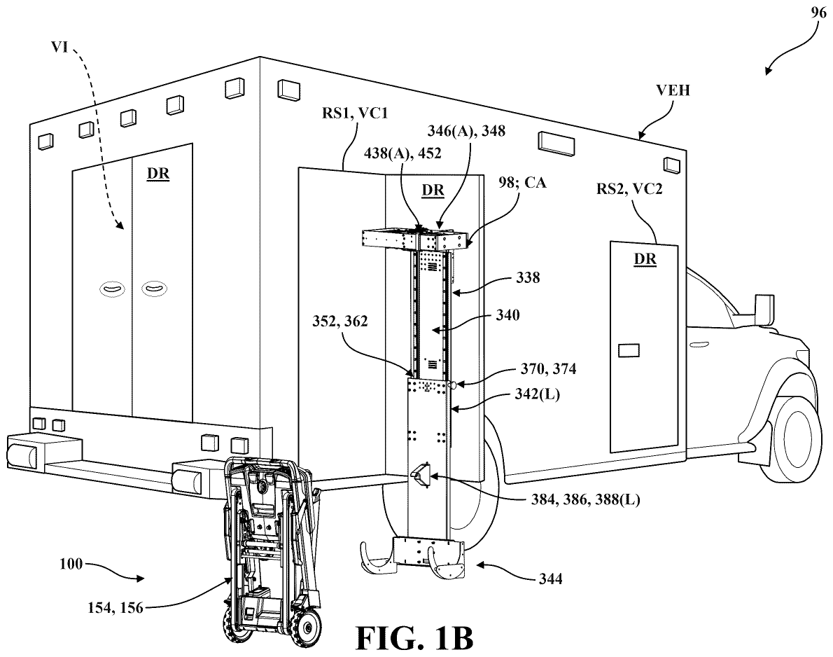

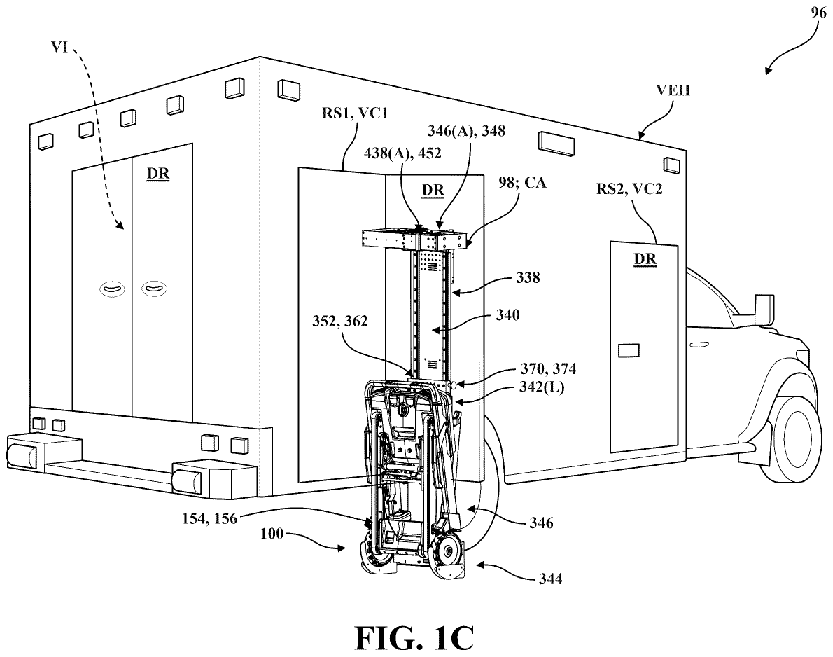

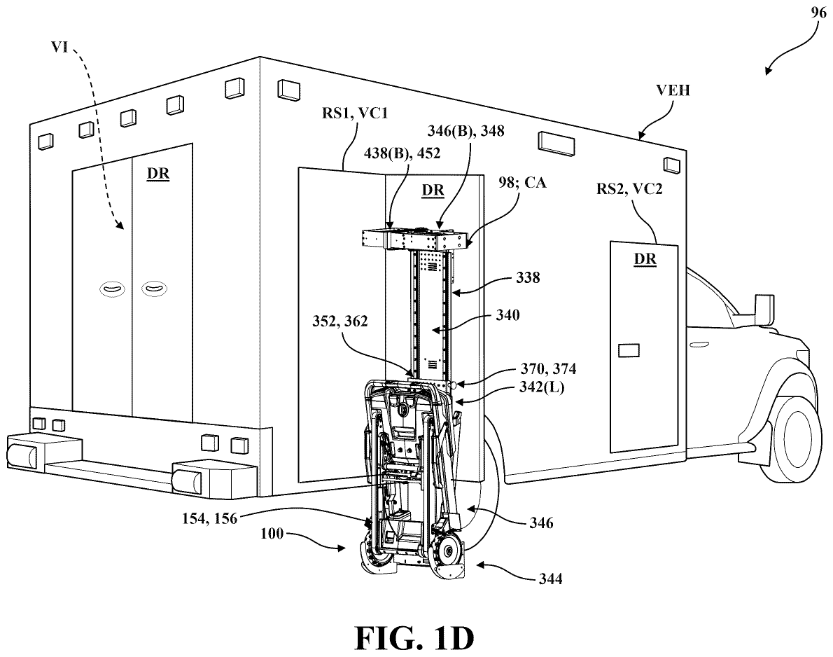

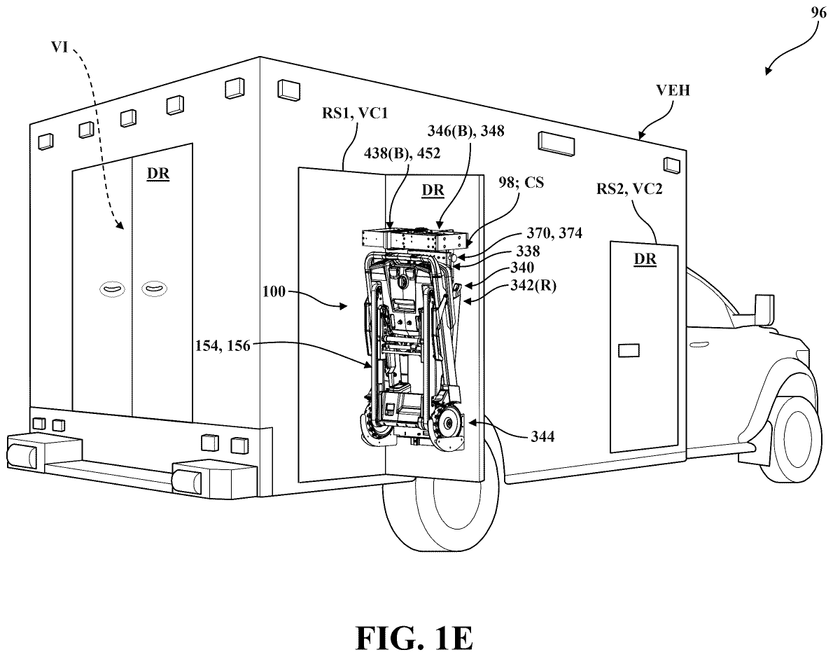

In FIGS. 1A-1E, a first exemplary transport vehicle VEH is shown as an ambulance. The transport vehicle VEH has an interior volume VI in which a patient and caregivers are located during use. The interior volume VI may include a system for loading an ambulance cot (not shown) to aid caregivers in loading the patient and cot into the transport vehicle VEH. In addition to the interior volume VI, the transport vehicle VEH may further comprise one or more storage compartments RS that define a corresponding cargo volume VC, which is accessible from an exterior of the transport vehicle VEH through a corresponding door DR. The storage compartments RS facilitate quick and easy access to equipment that a caregiver may need to aid a patient. The cargo volume VC of the storage compartment RS may further be accessible from the interior volume VI of the transport vehicle VEH in order to access the contents of the cargo volume VC while the transport vehicle VEH is moving.

In addition to the aforementioned cot, caregivers may also utilize other patient transport apparatuses 100 to facilitate patient transport during certain scenarios. More specifically, and according to versions of the present disclosure, the patient transport apparatus 100 illustrated throughout the drawings and described in greater detail below is realized as a “stair chair” which facilitates transporting a patient up and down a stairs ST. Generally, once the patient has reached the “ground floor” (i.e., the same as the transport vehicle VEH) of a particular location and is otherwise accessible by a wheeled ambulance cot, the patient is transferred from the patient transport apparatus 100 to wheeled ambulance cot and loaded into the interior volume VI of the transport vehicle VEH. As such, the patient is generally not transported within the transport vehicle VEH while seated in the patient transport apparatus 100. Said differently, unlike an ambulance cot, a patient transport apparatus 100 realized as a stair chair is intended to be unoccupied when transported by the transport vehicle VEH, and caregiver access to the stair chair while the transport vehicle VEH is in motion is unnecessary. It is therefore beneficial to minimize the storage volume required to transport the patient transport apparatus 100 within the transport vehicle VEH, which may likewise increase the difficulty of loading the patient transport apparatus 100 into the transport vehicle VEH, particularly when the patient transport apparatus 100 is heavy or unwieldy.

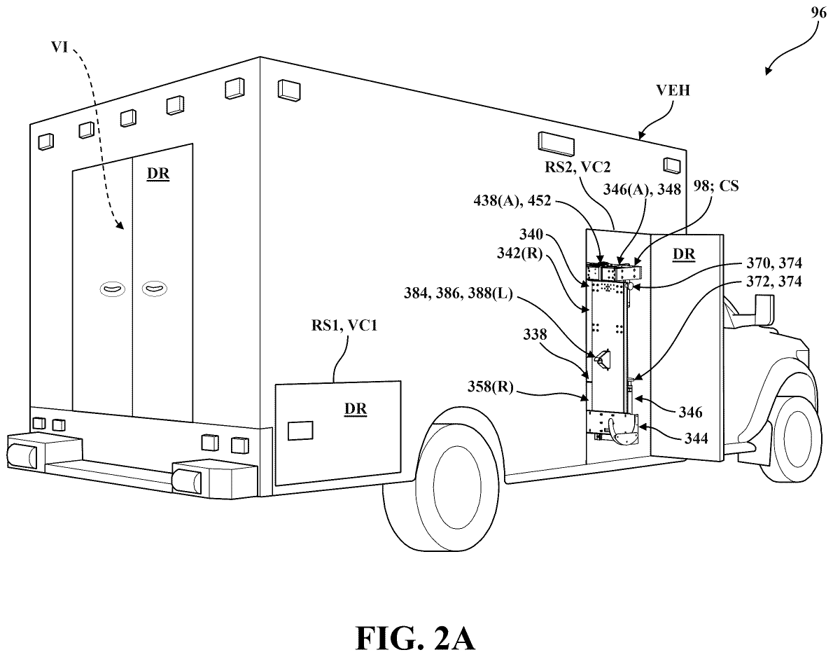

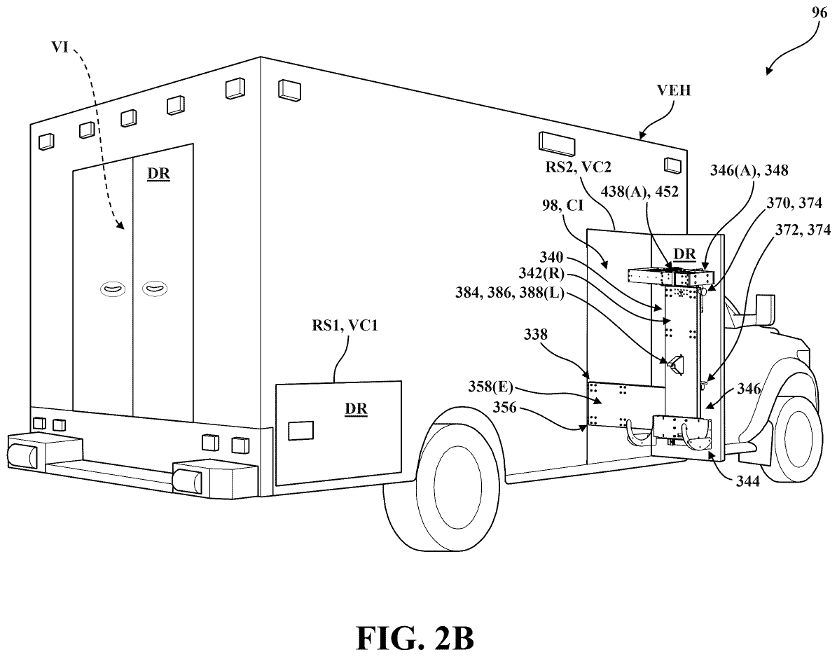

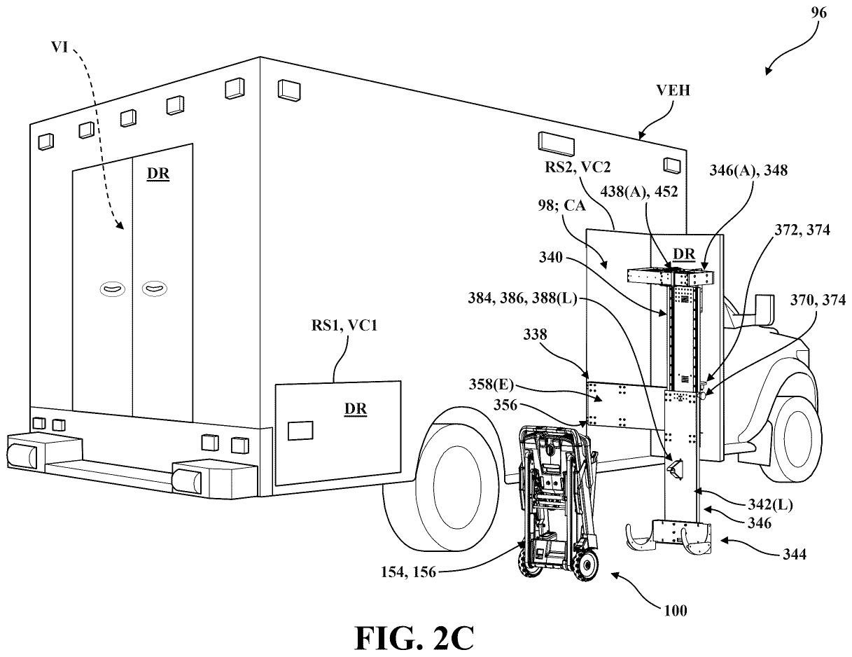

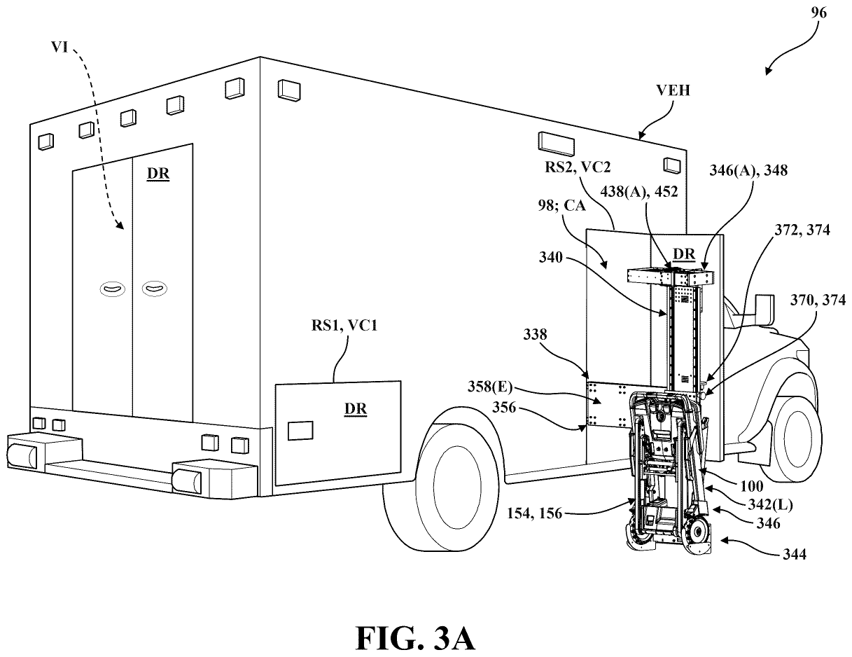

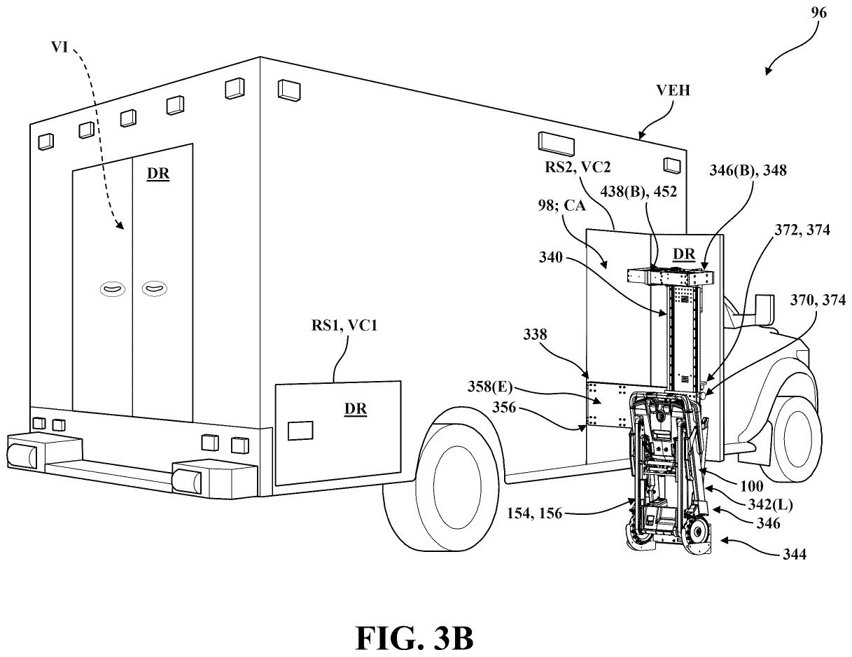

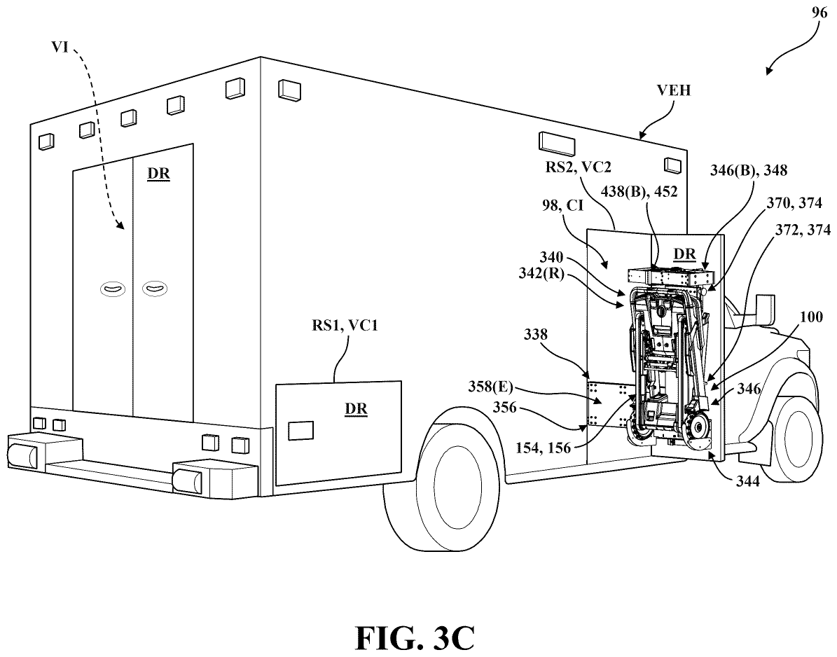

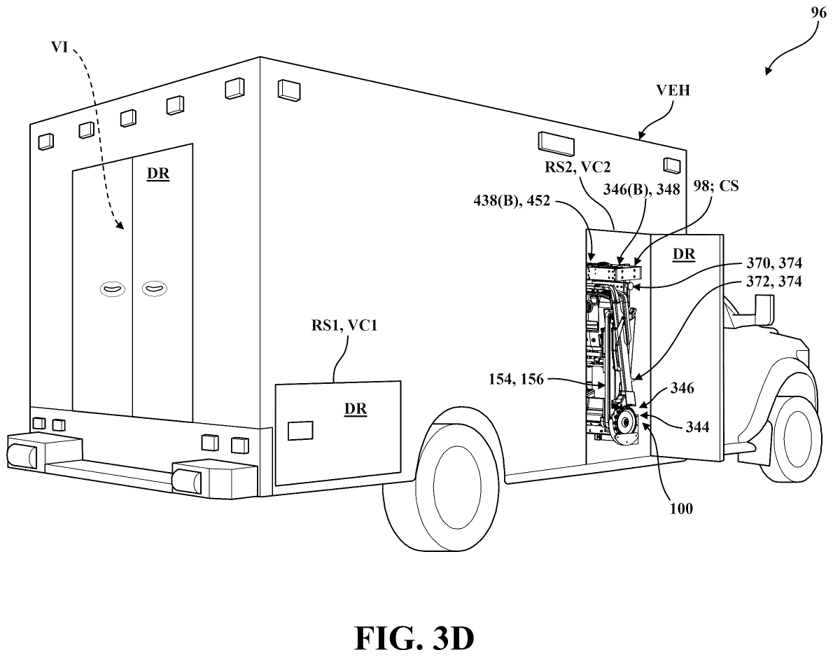

To this end, the loading device 98 of the system 96 may be used to facilitate loading the patient transport apparatus 100 onto the transport vehicle VEH. Because the patient transport apparatus 100 is not needed while the transport vehicle VEH is in transit (e.g., while driving between a medical facility and an accident scene), the patient transport apparatus 100 may advantageously be stored in one of the storage compartments RS accessible from the exterior of the transport vehicle VEH. The system 96 may aid lifting the patient transport apparatus 100 into the associated cargo volume VC, as well as lowering the patient transport apparatus 100 towards the ground or floor surface FS. FIGS. 1A-1E illustrate a first such arrangement whereby the transport vehicle VEH has a first storage compartment RS1 with the loading device 98 being configured to lift the patient transport apparatus 100 for placement into a first cargo volume VC1. In this version, the loading device 98 is configured to facilitate vertical movement of the patient transport apparatus 100 and is operatively attached to the door DR which, in turn, can be subsequently pivoted to position the loading device 98 loaded with the patient transport apparatus 100 into the first cargo volume VC1 (pivoting not shown in detail). While this version illustrates the door DR as being accessible from a lateral side of the transport vehicle VEH, it will be appreciated that the loading device 98 can be coupled to other doors DR of the vehicle VEH (e.g., such as to a rear door; not shown in detail) or to other components of the vehicle VEH at other locations. Furthermore, and as will be appreciated from the subsequent description of the system 96 below, the loading device 98 can be configured to move in other ways in addition to vertically. By way of illustrative example, FIGS. 2A-3D depict a version of the system 96 where the transport vehicle VEH has a second storage compartment RS2 and the loading device 98 is configured to facilitate both vertical and horizontal movement of the patient transport apparatus 100. Here, rather than being operatively attached to the door DR which provides access to a second cargo volume VC2 from the exterior of the transport vehicle VEH, the loading device 98 is instead operatively attached to a wall or floor (not shown) of the vehicle VEH disposed within the second cargo volume VC2. In some versions, aspects of the loading device 98 and/or other portions of the system 96 may be similar to as is disclosed in International Patent Application No. PCT/US2024/026390 filed on Apr. 26, 2024 and entitled “Folding Loading Systems For Patient Transport Apparatuses,” and/or in International Patent Application No. PCT/US2024/026391 filed on Apr. 26, 2024 and entitled “Loading Systems For Patient Transport Apparatuses,” the disclosures of each of which are hereby incorporated by reference in their entirety. The loading device 98 and the patient transport apparatus 100 of the system 96 introduced above will be described in greater detail below.

As is best shown in FIGS. 4-5, the patient transport apparatus 100 comprises a support structure 102 to which a seat section 104 and a back section 106 are operatively attached. The seat section 104 and the back section 106 are each shaped and arranged to provide support to the patient during transport. The support structure 102 generally includes a rear support assembly 108, a front support assembly 110, and an intermediate support assembly 112. The back section 106 is coupled to the rear support assembly 108 for concurrent movement. To this end, the rear support assembly 108 comprises a first rear upright 114A arranged on a first side of the rear support assembly 108. The rear support assembly 108 may further comprise a second read upright 114B on a second side of the rear support assembly 108, opposite the first side. The rear uprights 114A, 114B may extend generally vertically and are secured to the back section 106 such as with fasteners (not shown in detail).

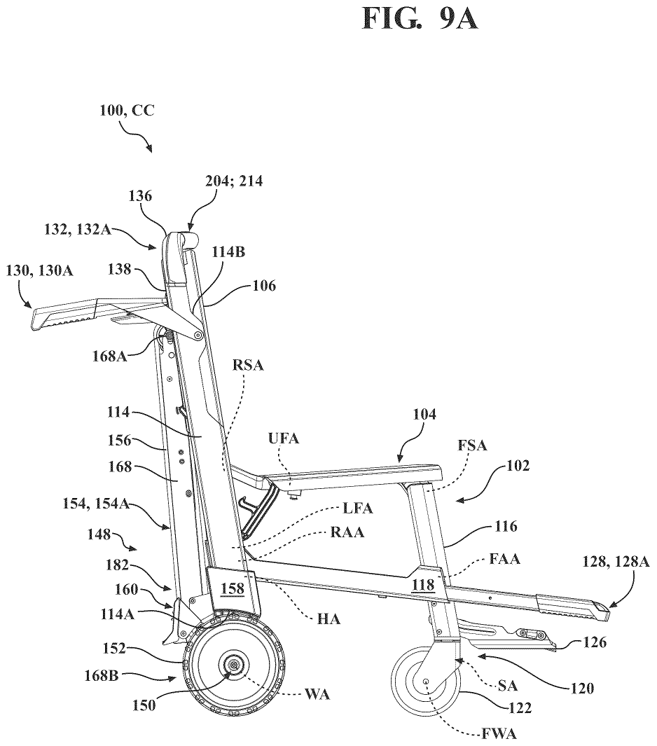

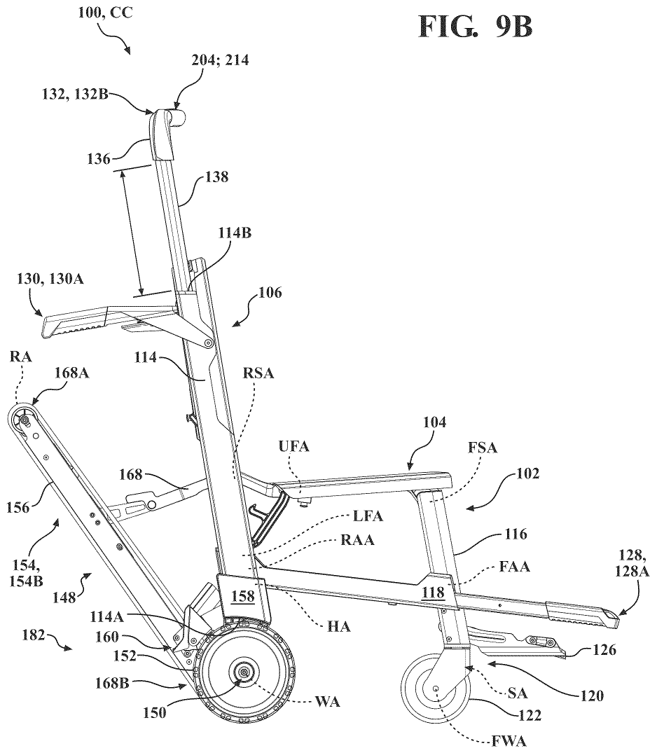

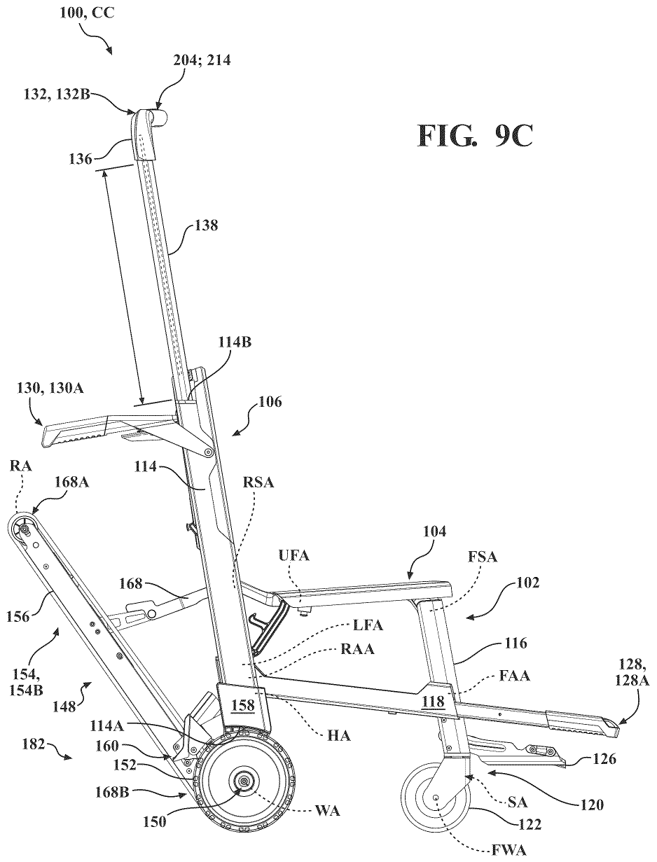

The intermediate support assembly 112 and the seat section 104 are each pivotably coupled to the rear support assembly 108. More specifically, the seat section 104 is arranged so as to pivot about a rear seat axis RSA which extends through the rear uprights 114A, 114B (compare FIGS. 8-9A; pivoting about rear seat axis RSA not shown in detail), and the intermediate arms 118 of the intermediate support assembly 112 are arranged so as to pivot about a rear arm axis RAA which is spaced from the rear seat axis RSA and also extends through the rear uprights 114A, 114B (compare FIGS. 8-9A; pivoting about rear arm axis RAA not shown in detail). Furthermore, the intermediate support assembly 112 and the seat section 104 are also each pivotably coupled to the front support assembly 110. Here, the seat section 104 pivots about a front seat axis FSA which extends through the front struts 116 (compare FIGS. 8-9A; pivoting about front seat axis FSA not shown in detail), and the intermediate arms 118 pivot about a front arm axis FAA which is spaced from the front seat axis FSA and extends through the front struts 116 (compare FIGS. 8-9A; pivoting about front arm axis FAA not shown in detail). The intermediate support assembly 112 is disposed generally vertically below the seat section 104 such that the rear support assembly 108, the front support assembly 110, the intermediate support assembly 112, and the seat section 104 generally define a four-bar linkage which helps facilitate movement between the stowed configuration FC (see FIG. 8) and the chair configuration CC (see FIG. 9A). While the seat section 104 is generally configured to remain stationary relative to the support structure 102 when operating in the chair configuration CC or in the stair configuration CC according to the illustrated versions, it is contemplated that the seat section 104 could comprise multiple components which cooperate to facilitate “sliding” movement relative to the seat section 104 under certain operating conditions, such as to position the patient's center of gravity advantageously for transport. Other configurations are contemplated.

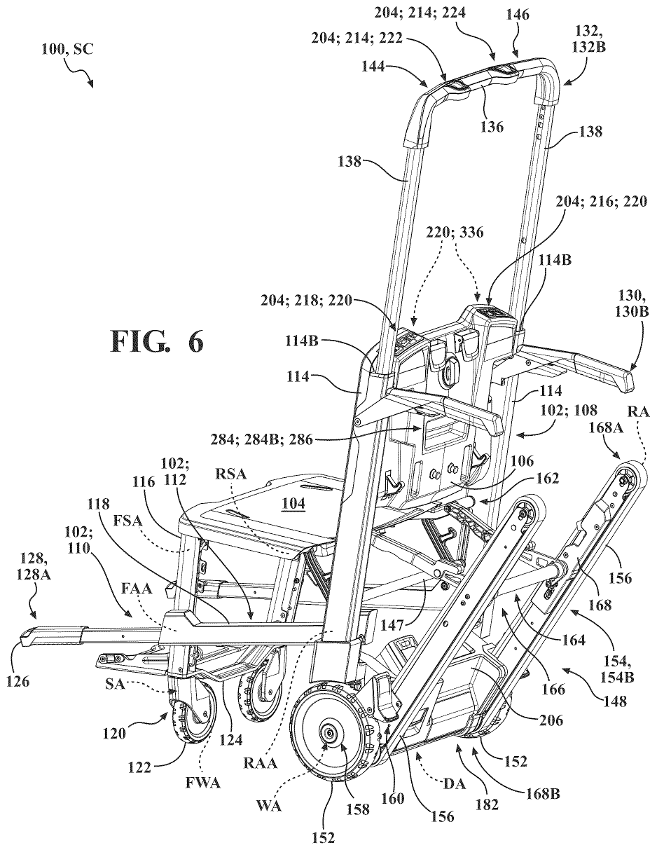

Referring now to FIGS. 4-6, the front support assembly 110 includes a pair of caster assemblies 120 which each comprise a front wheel 122 arranged to rotate about a respective front wheel axis FWA and to pivot about a respective swivel axis SA (compare FIGS. 8-9A; pivoting about swivel axis SA not shown in detail). The caster assemblies 120 are generally arranged on opposing lateral sides of the front support assembly 110 and are operatively attached to the front struts 116. A lateral brace 124 (see FIG. 6) extends laterally between the front struts 116 to, among other things, afford rigidity to the support structure 102. Here, a foot rest 126 is pivotably coupled to each of the front struts 116 adjacent to the caster assemblies 120 (pivoting not shown in detail) to provide support to the patient's feet during transport. For each of the pivotable connections disclosed herein, it will be appreciated that one or more fasteners, bushings, bearings, washers, spacers, and the like may be provided to facilitate smooth pivoting motion between various components.

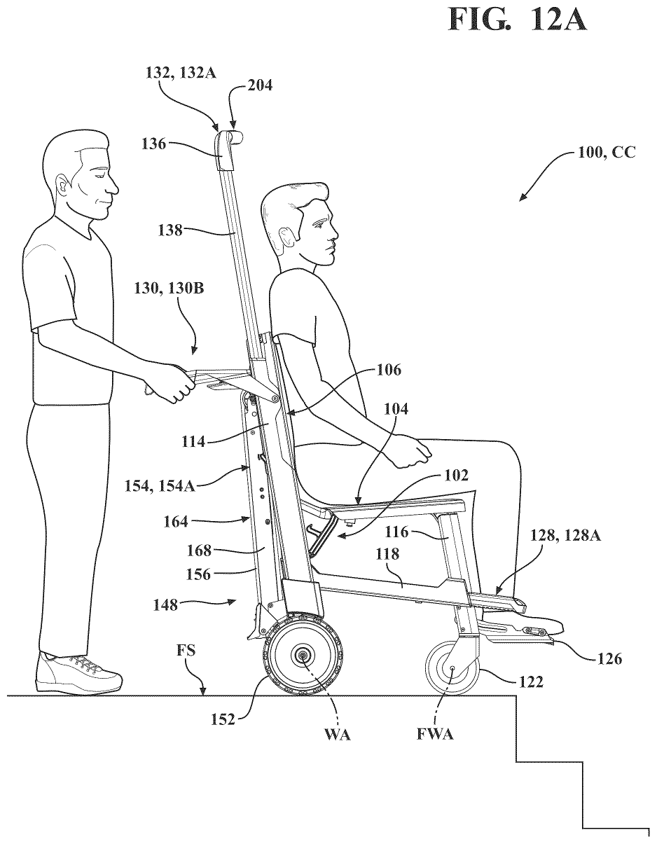

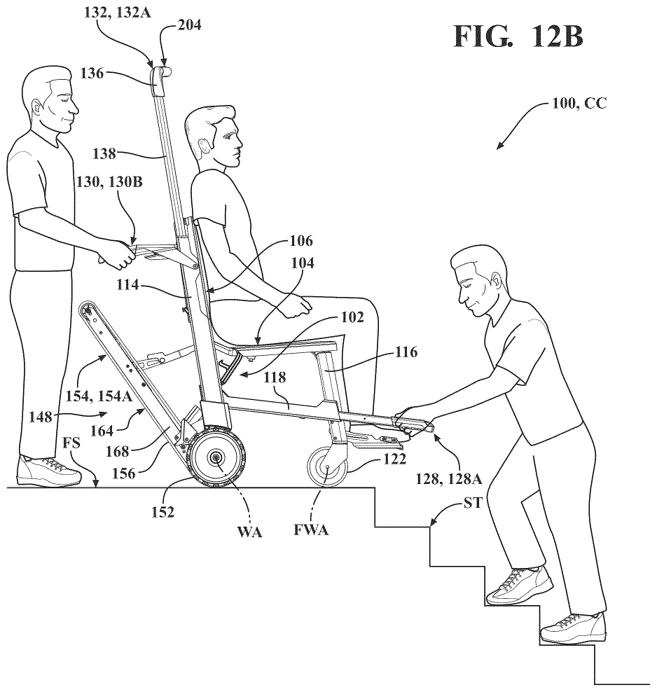

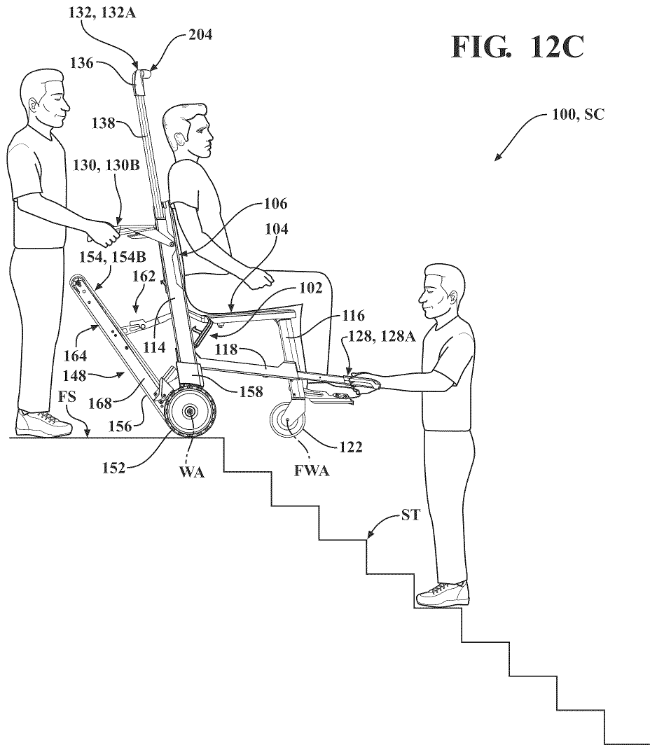

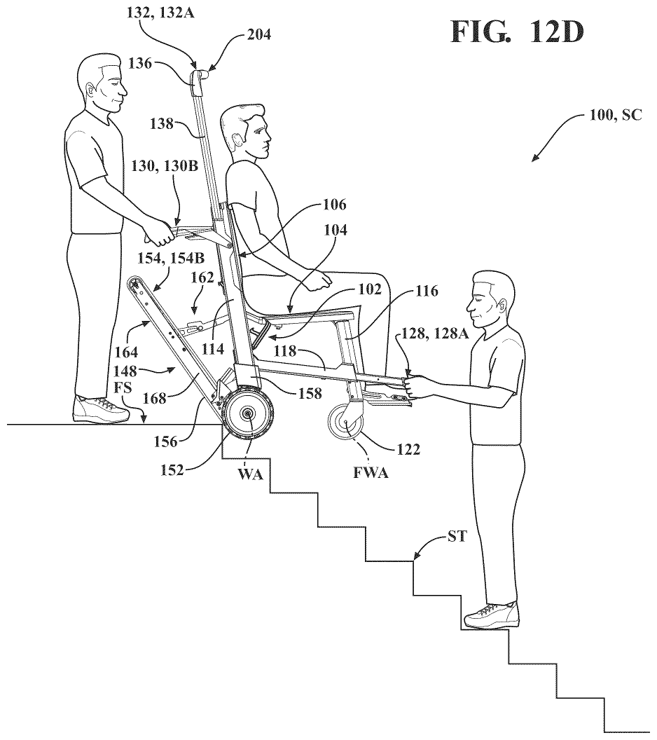

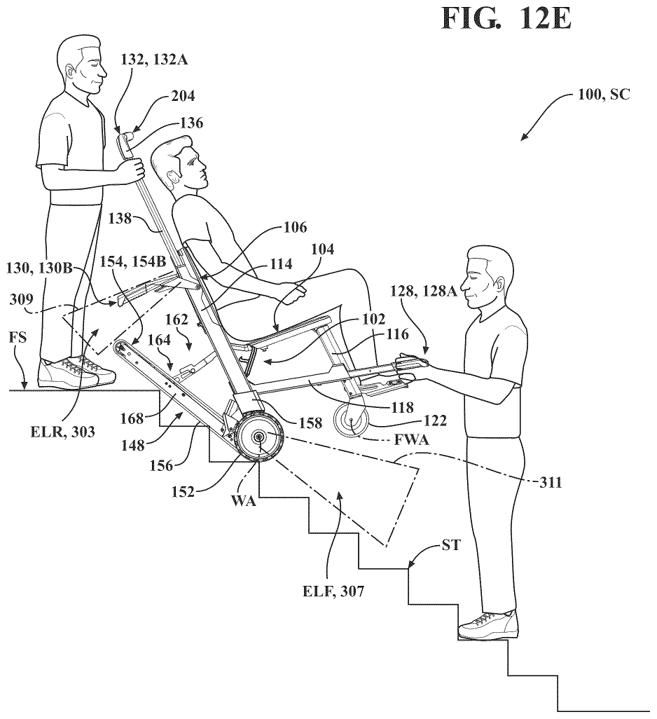

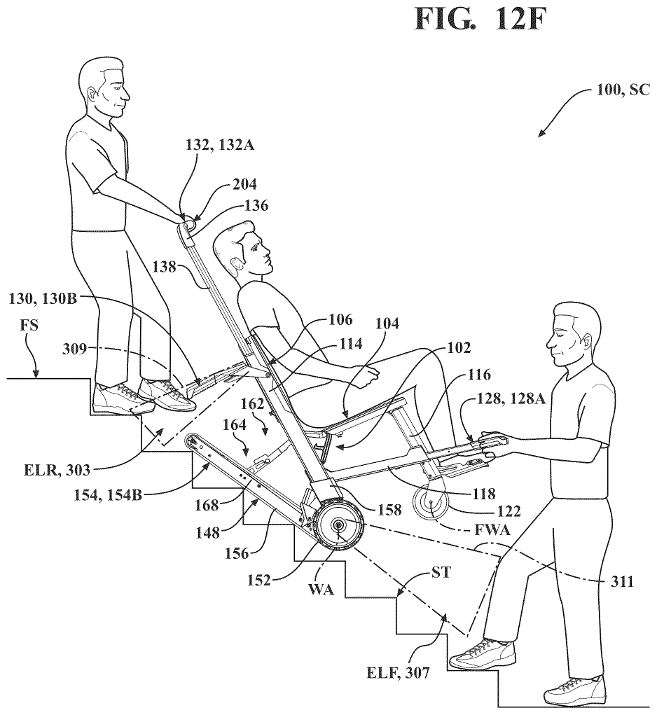

The representative versions of the patient transport apparatus 100 illustrated throughout the drawings comprise different handles arranged for engagement by caregivers during patient transport. More specifically, the patient transport apparatus 100 comprises front handle assemblies 128, pivoting handle assemblies 130, and an upper handle assembly 132 (hereinafter referred to as “handle assembly 132”), each of which will be described in greater detail below. The front handle assemblies 128 are supported within the respective intermediate arms 118 for movement between a collapsed position 128A (see FIG. 12A) and an extended position 128B (see FIG. 12B). To this end, the front handle assemblies 128 may be slidably supported by bushings, bearings, and the like (not shown) coupled to the intermediate arms 118, and may be lockable in and/or between the collapsed position 128A and the extended position 128B via respective front handle locks 134 (see FIG. 5).

Here, a caregiver may engage the front handle locks 134 (not shown in detail) to facilitate moving the front handle assemblies 128 between the collapsed position 128A and the extended position 128B. The front handle assemblies 128 are generally arranged so as to be engaged by a caregiver during patient transport up or down stairs ST when in the extended position 128B. It will be appreciated that the front handle assemblies 128 could be of various types, styles, and/or configurations suitable to be engaged by caregivers to support the patient transport apparatus 100 for movement. While the illustrated front handle assemblies 128 are arranged for telescoping movement, other configurations are contemplated. By way of non-limiting example, the front handle assemblies 128 could be pivotably coupled to the support structure 102 or other parts of the patient transport apparatus 100. In some versions, the front handle assemblies 128 could be configured similar to as is disclosed in U.S. Pat. No. 6,648,343, the disclosure of which is hereby incorporated by reference in its entirety.

The pivoting handle assemblies 130 are coupled to the respective rear uprights 114A, 114B of the rear support assembly 108, and are movable relative to the rear uprights 114A, 114B between a stowed position 130A and an engagement position 130B. Like the front handle assemblies 128, the pivoting handle assemblies 130 are generally arranged for engagement by a caregiver during patient transport, and may advantageously be utilized in the engagement position 130B when the patient transport apparatus 100 operates in the chair configuration CC to transport the patient along floor surfaces FS. In some versions, the pivoting handle assemblies 130 could be configured similar to as is disclosed in U.S. Pat. No. 6,648,343, previously incorporated by reference. Other configurations are contemplated.

As is best depicted in FIG. 9A, the rear uprights 114A, 114B each generally extend between a lower upright end 115A and an upper upright end 115B, with the hub axis HA arranged adjacent to the lower upright end 115A. The lower upright end 115A is supported for movement within the hub 158, which may comprise a hollow profile or recess defined by multiple hub housing components. In the illustrated version, the hub axis HA is arranged generally vertically between the rear arm axis RAA and the wheel axis WA. The rear uprights 114A, 114B may each comprise a generally hollow, extruded profile which supports various components of the patient transport apparatus 100.

As best shown in FIG. 5, the handle assembly 132 includes an upper grip 136. The upper grip 136 is operatively attached to a first extension post 138A. The first extension post 138A is disposed within the first rear upright 114A. Accordingly, the first extension post 138A supports the upper grip 136 for movement of the handle assembly 132 between a collapsed position 132A where the upper grip is disposed adjacent to the user interface (see FIG. 5 and an extended position 132B where the upper grip is spaced from the user interface (see FIG. 4). In some examples, the upper grip 136 may extend between a first upper grip end 136A and a second upper grip end 136B. The first extension post 138A may be operatively attached to the first upper grip end 136A. The handle assembly 132 may further include a second extension post 138B operatively attached to the second upper grip end 136B. Together, the first and second extension posts 138A, 138B may support the upper grip 136 for movement of the handle assembly 132 between the collapsed position 132A and the extended position 132B.

In the representative version illustrated herein, the upper grip 136 generally comprises a first hand grip region 144 arranged adjacent to the first extension posts 138A, and a second hand grip region 146 arranged adjacent to the second extension post 138B, each of which may be engaged by the caregiver to support the patient transport apparatus 100 for movement, such as during patient transport up or down stairs ST (see FIGS. 12A-12F). The activation input controls 214 may be arranged in various locations about the patient transport apparatus 100. In the illustrated versions, a first activation input control 222 is disposed adjacent to the first hand grip region 144 of the handle assembly 132, and a second activation input control 224 is disposed adjacent to the second hand grip region 146 (best shown in FIG. 5). In the illustrated version, the user interface 204 is configured such that the caregiver can engage either of the activation input controls 222, 224 with a single hand grasping the upper grip 136 (described below) of the handle assembly 132 during use.

The activation input controls 214 may be arranged between the first and second hand grip regions 144, 146 in order to facilitate user engagement of the activation input controls 214 from either of the first and second hand grip regions 144, 146. As previously discussed, the activation input controls 214 include the first activation input control 222 and the second activation input control 224. The first activation input control 222 may be disposed adjacent the first hand grip region 144 so as to facilitate user engagement of the first activation input control 222 from the first hand grip region 144. The second activation input control 224 may be disposed adjacent to the second hand grip region 146 so as to facilitate user engagement of the second activation input control 224 from the second hand grip region 146. Here, it will be appreciated that the user can engage either of the first and second hang grip regions 144, 146 with one of their hands to support the patient transport apparatus 100 while, at the same, using that same hand to activate one of the first and second activation input controls 222, 224 (e.g., reaching with their thumb).

The first activation input control 222 and the second activation input control 224 may be spaced apart by a predetermined distance (e.g., several inches) and are wired in parallel in some versions (not shown in detail).

Referring to FIGS. 9A-9C, the handle assembly 132 is configured for movement between the extended position 132B (shown in FIG. 9A) where the upper grip 136 is spaced from the user interface 204 at a first distance D1, and the collapsed position 132A (shown in FIG. 9C) where the upper grip 136 is disposed adjacent to the user interface 204. Additionally, the handle assembly 132 may be configured for movement to an intermediate position 132C (shown in FIG. 9B) where the upper grip 136 is spaced from the user interface 204 at a second distance D2, less than the first distance D1.

As noted above, the patient transport apparatus 100 is configured for use in transporting the patient across floor surfaces FS, such as when operating in the stair configuration SC, and for transporting the patient along stairs ST when operating in the stair configuration SC. To these ends, the illustrated patient transport apparatus 100 includes one or more frame elements 147, a carrier assembly 148 arranged for movement relative to the support structure 102 between the chair configuration CC and the stair configuration ST. The carrier assembly 148 generally comprises at least one shaft 150 defining a wheel axis WA, one or more rear wheels 152 supported for rotation about the wheel axis WA, at least one track assembly 154 having a belt 156 for engaging stairs ST, and one or more hubs 158 supporting the shaft 150 and the track assembly 154 and the shaft 150 for concurrent pivoting movement about a hub axis HA. Here, movement of the carrier assembly 148 from the chair configuration CC (see FIG. 5) to the stair configuration SC (see FIGS. 4 and 9B) simultaneously deploys the track assembly 154 for engaging stairs ST with the belt 156 and moves the wheel axis WA longitudinally closer to the front support assembly 110 so as to position the rear wheels 152 further underneath the seat section 104 and closer to the front wheels 122.

As is described in greater detail below in connection with FIGS. 12A-12F, the movement of the rear wheels 152 relative to the front wheels 122 when transitioning from the chair configuration CC to the stair configuration SC that is afforded by the patient transport apparatus 100 of the present disclosure affords significant improvements in patient comfort and caregiver usability, in that the rear wheels 152 are arranged to promote stable transport across floor surfaces FS in the chair configuration CC but are arranged to promote easy transitioning from floor surfaces to stairs ST as the patient transport apparatus 100 is “tilted” backwards about the rear wheels 152 (compare FIGS. 12D-12F). Put differently, positioning the rear wheels 152 relative to the front wheels 122 consistent with the present disclosure makes “tilting” the patient transport apparatus 100 significantly less burdensome for the caregivers and, at the same time, much more comfortable for the patient due to the arrangement of the patient's center of gravity relative to the portion of the rear wheels 152 contacting the floor surface FS as the patient transport apparatus 100 is “tilted” backwards to transition into engagement with the stairs ST.

In the representative versions illustrated herein, the carrier assembly 148 comprises hubs 158 that are pivotably coupled to the respective rear uprights 114A, 114B for concurrent movement about the hub axis HA. Here, one or more bearings, bushings, shafts, fasteners, and the like (not shown in detail) may be provided to facilitate pivoting motion of the hubs 158 relative to the rear uprights 114A, 114B. Similarly, bearings and/or bushings (not shown) may be provided to facilitate smooth rotation of the rear wheels 152 about the wheel axis WA. Here, the shafts 150 may be fixed to the hubs 158 such that the rear wheels 152 rotate about the shafts 150 (e.g., about bearings supported in the rear wheels 152), or the shafts 150 could be supported for rotation relative to the hubs 158. Each of the rear wheels 152 is also provided with a wheel lock 160 coupled to its respective hub 158 to facilitate inhibiting rotation about the wheel axis WA. The wheel locks 160 are generally pivotable relative to the hubs 158, and may be configured in a number of different ways without departing from the scope of the present disclosure. While the representative version of the patient transport apparatus 100 illustrated herein employs hubs 158 with “mirrored” profiles that are coupled to the respective rear uprights 114A, 114B and support discrete shafts 150 and wheel locks 160, it will be appreciated that a single hub 158 and/or a single shaft 150 could be employed. Other configurations are contemplated.

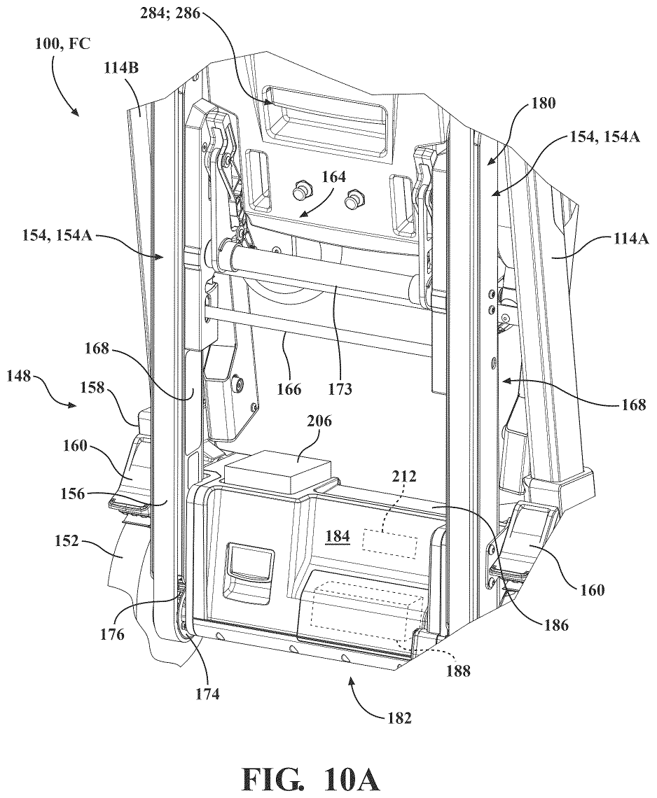

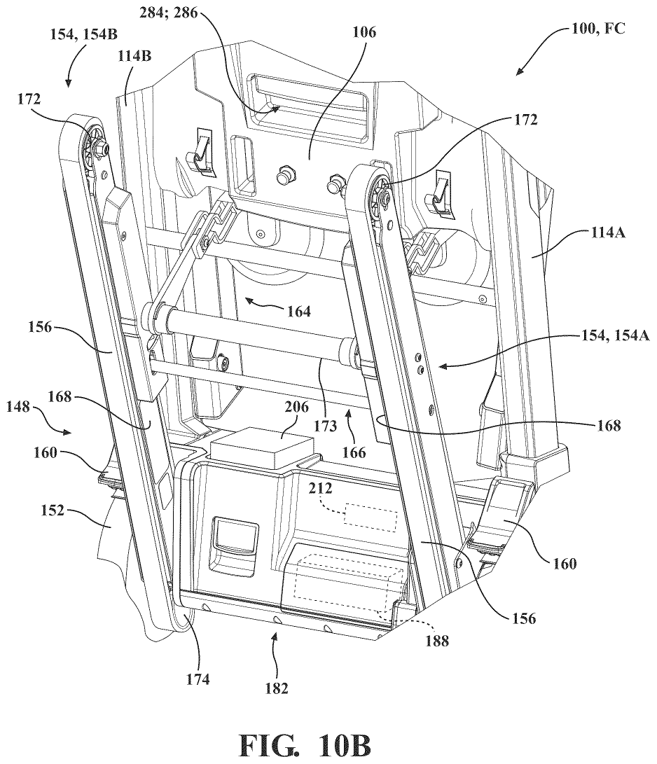

Referring now to FIGS. 10A-10B, the illustrated version of the patient transport apparatus 100 employs a pair of track assemblies 154 which move concurrently with the hubs 158 between the chair configuration CC and the stair configuration SC. Here, the track assemblies 154 are arranged in a retracted position 154A when the carrier assembly 148 is disposed in the chair configuration CC, and are disposed in a deployed position 154B when the carrier assembly 148 is disposed in the stair configuration SC. As is described in greater detail below, the illustrated patient transport apparatus 100 comprises a deployment linkage 162 and a deployment lock mechanism 164 with a deployment lock release 166 arranged for engagement by the caregiver to facilitate changing between the retracted position 154A and the deployed position 154B (and, thus, between the chair configuration CC and the stair configuration SC).

In the illustrated version, the patient transport apparatus 100 comprises laterally-spaced track assemblies 154 each having a single belt 156 arranged to contact stairs ST. However, it will be appreciated that other configurations are contemplated, and a single track assembly 154 and/or track assemblies with multiple belts 156 could be employed. The track assemblies 154 each generally comprise a track rail 168 extending between a first rail end 168A and a second rail end 168B. The second rail end 168B is operatively attached to the hub 158, such as with one or more fasteners (not shown in detail). An axle 170 defining a roller axis RA is disposed adjacent to the first rail end 168A of each track rail 168, and a roller 172 is supported for rotation about the roller axis RA. For each of the track assemblies 154, the belt 156 is disposed in engagement with the roller 172 and is arranged for movement relative to the track rail 168 in response to rotation of the roller 172 about the roller axis RA.

The track assemblies 154 may further comprise a cross brace 173 extending laterally therebetween. The cross brace 173 is coupled to the track rail 168 of each track assembly 154 to effect coordinated motion of the track assemblies 154. Said differently, movement of one of the track assemblies 154 between the retracted position 154A and the deployed position 154B causes corresponding movement of the other track assembly 154. The cross brace 173 may further provide increased resistance to deflection of the track assemblies 154 when subjected to lateral loads near the first rail end 168A by transferring force exerted on one track assembly 154 to the other track assembly 154. The cross brace 173 may be coupled to the rails 168 with threaded fasteners or may be permanently coupled to the rails 168 by way of a welding process.

Adjacent to the second rail end 168B of each track rail 168, a drive pulley 174 is supported for rotation about a drive axis DA and is likewise disposed in engagement with the belt 156 (see FIGS. 10A-10B; rotation about drive axis DA not shown in detail). Here, the drive pulley 174 comprises outer teeth 176 which are disposed in engagement with inner teeth 178 formed on the belt 156. The track assemblies 154 each also comprise a belt tensioner, generally indicated at 180, configured to adjust tension in the belt 156 between the roller 172 and the drive pulley 174.

In the representative version illustrated herein, the patient transport apparatus 100 comprises a drive system, generally indicated at 182, configured to facilitate driving the belts 156 of the track assemblies 154 relative to the rails 168 to facilitate movement of the patient transport apparatus 100 up and down stairs ST. To this end, and as is depicted in FIG. 10A, the drive system 182 comprises a drive frame 184 and a cover 186 which are operatively attached to the hubs 158 of the carrier assembly 148 for concurrent movement with the track assemblies 154 between the retracted position 154A and the deployed position 154B. A motor 188 (depicted in phantom in FIG. 10A) is coupled to the drive frame 184 and is concealed by the cover 186. The motor 188 is configured to selectively generate rotational torque used to drive the belts 156 via the drive pullies 174, as described in greater detail below. To this end, a drive axle 190 is coupled to each of the drive pullies 174 and extends along the drive axis DA laterally between the track assemblies 154. The drive axle 190 is rotatably supported by the drive frame 184, such as by one or more bearings, bushings, and the like (not shown in detail). A geartrain 192 is disposed in rotational communication between the motor 188 and the drive axle 190. To this end, in the version depicted in FIG. 10A, the geartrain 192 comprises a first sprocket 194, a second sprocket 196, and an endless chain 198. Here, the motor 188 comprises an output shaft 200 to which the first sprocket 194 is coupled, and the second sprocket 196 is coupled to the drive axle 190. The endless chain 198, in turn, is supported about the first sprocket 194 and the second sprocket 196 such that the drive axle 190 and the output shaft 200 rotate concurrently. The geartrain 192 may be configured so as to adjust the rotational speed and/or torque of the drive axle 190 relative to the output shaft 200 of the motor, such as by employing differently-configured first and second sprockets 194, 196 (e.g., different diameters, different numbers of teeth, and the like).

While the representative version of the drive system 182 illustrated herein utilizes a single motor 188 to drive the belts 156 of the track assemblies 154 concurrently using a chain-based geartrain 192, it will be appreciated that other configurations are contemplated. By way of non-limiting example, multiple motors 188 could be employed, such as to facilitate driving the belts 156 of the track assemblies 154 independently. Furthermore, different types of geartrains 192 are contemplated by the present disclosure, including without limitation the geartrains 192 which comprise various arrangements of gears, planetary gearsets, and the like.

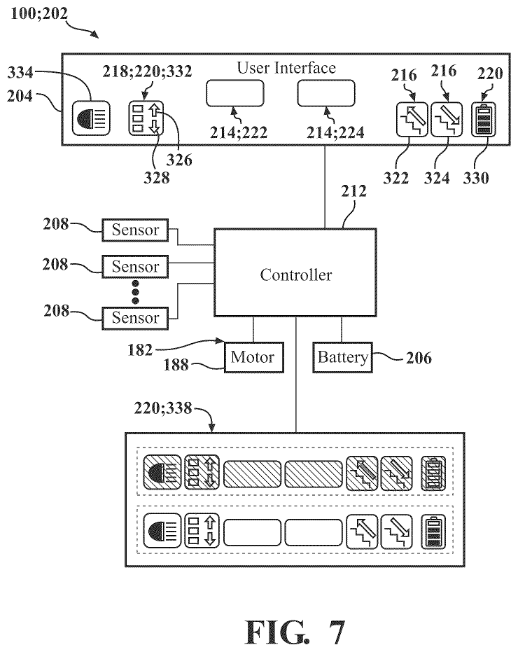

The patient transport apparatus 100 comprises a control system 202 to, among other things, facilitate control of the track assemblies 154. To this end, and as is depicted schematically in FIG. 7, the representative version of the control system 202 generally comprises a user interface 204, a battery 206, one or more sensors 208, and one or more back light modules 210 which are disposed in electrical communication with a controller 212. As will be appreciated from the subsequent description below, the controller 212 may be of a number of different types, styles, and/or configurations, and may employ one or more microprocessors for processing instructions or an algorithm stored in memory to control operation of the motor 188, the light modules 210, and the like. Additionally or alternatively, the controller 212 may comprise one or more sub-controllers, microcontrollers, field programmable gate arrays, systems on a chip, discrete circuitry, and/or other suitable hardware, software, and/or firmware that is capable of carrying out the functions described herein.

The controller 212 is coupled to various electrical components of the patient transport apparatus 100 (e.g., the motor 188) in a manner that allows the controller 212 to control or otherwise interact with those electrical components the (e.g., via wired and/or wireless electrical communication). In some versions, the controller 212 may generate and transmit control signals to the one or more powered devices, or components thereof, to drive or otherwise facilitate operating those powered devices, or to cause the one or more powered devices to perform one or more of their respective functions.

The controller 212 may utilize various types of sensors 208 of the control system 202, including without limitation force sensors (e.g., load cells), timers, switches, optical sensors, electromagnetic sensors, motion sensors, accelerometers, potentiometers, infrared sensors, ultrasonic sensors, mechanical limit switches, membrane switches, encoders, and/or cameras. One or more sensors 208 may be used to detect mechanical, electrical, and/or electromagnetic coupling between components of the patient transport apparatus 100. Other types of sensors 208 are also contemplated. Some of the sensors 208 may monitor thresholds movement relative to discrete reference points. The sensors 208 can be located anywhere on the patient transport apparatus 100, or remote from the patient transport apparatus 100. Other configurations are contemplated.

The battery 206 provides power to the controller 212, the motor 188, the light modules 210, and other components of the patient transport apparatus 100 during use, and is removably attachable to the cover 186 of the drive system 182 in the illustrated version (see FIG. 10A; attachment not shown in detail). The user interface 204 is generally configured to facilitate controlling the drive direction and drive speed of the motor 188 to move the belts 156 of the track assembly 154 and, thus, allow the patient transport apparatus 100 to ascend or descend stairs ST. Here, the user interface 204 may comprise one or more activation input controls 214 to facilitate driving the motor 188 in response to engagement by the caregiver, one or more direction input controls 216 to facilitate changing the drive direction of the motor 188 in response to engagement by the caregiver, and/or one or more speed input controls 218 to facilitate operating the motor 188 at different predetermined speeds selectable by the caregiver. The one or more direction input controls 216 and the one or more speed input controls 218 may be coupled to the rear support assembly 108 and referred to as lower input controls 219. The user interface 204 may also comprise various types of indicators 220 to display information to the caregiver. It will be appreciated that the various components of the control system 202 introduced above could be configured and/or arranged in a number of different ways, and could communicate with each other via one or more types of electrical communication facilitated by wired and/or wireless connections. Other configurations are contemplated.

In the illustrated versions, the patient transport apparatus 100 is configured to limit movement of the belts 156 relative to the rails 168 during transport along stairs ST in an absence of engagement with the activation input controls 214 by the caregiver. Put differently, one or more of the controller 212, the motor 188, the geartrain 192, and/or the track assemblies 154 may be configured to “brake” or otherwise prevent movement of the belts 156 unless the activation input controls 214 are engaged. To this end, the motor 188 may be controlled via the controller 212 to prevent rotation (e.g., driving with a 0% pulse-width modulation PWM signal) in some versions. However, other configurations are contemplated, and the patient transport apparatus 100 could be configured to prevent movement of the belts 156 in other ways. By way of non-limiting example, a mechanical brake system (not shown) could be employed in some versions.

Referring now to FIG. 10A, the patient transport apparatus 100 employs the deployment lock mechanism 164 to releasably secure the track assembly 154 in the retracted position 154A and in the deployed position 154B. The deployment lock release 166 is arranged for engagement by the caregiver to move between the retracted position 154A and the deployed position 154B. The deployment lock mechanism 164 is coupled to the track assemblies 154 for concurrent movement, and the deployment linkage 162 is coupled between the deployment lock mechanism 164 and the support structure 102. The illustrated deployment linkage 162 generally comprises connecting links 226 which are pivotably coupled to the support structure 102, and brace links 228 which are coupled to the deployment lock mechanism 164 and are respectively pivotably coupled to the connecting links 226.

The connecting links 226 each comprise or otherwise define a forward pivot region 230, a connecting pivot region 232, a trunnion region 234, and an interface region 236. The forward pivot regions 230 extend from the interface regions 236 to forward pivot mounts 238 which are pivotably coupled to the rear uprights 114A, 114B about the rear seat axis RSA, such as by one or more fasteners, bushings, bearings, and the like (not shown in detail). Here, because the rear uprights 114A, 114B are spaced laterally away from each other at a distance large enough to allow the track assemblies 154 to “nest” therebetween in the retracted position 154A (see FIG. 10A), the forward pivot regions 230 of the connecting links 226 extend at an angle away from the rear uprights 114A, 114B at least partially laterally towards the track assemblies 154.

The trunnion regions 234 extend generally vertically downwardly from the interface regions 236 to trunnion mount ends 240, and comprise trunnions 242 which extend generally laterally and are arranged to abut trunnion catches 244 of the deployment lock mechanism 164 to retain the track assemblies 154 in the retracted position 154A (see FIG. 10A). The connecting pivot regions 232 extend longitudinally away from the interface regions 236 to rearward pivot mounts 246 which pivotably couple to the brace links 228 about a link axis LA. The connecting links 226 are each formed as separate components with mirrored profiles in the illustrated versions, but could be realized in other ways, with any suitable number of components.

The brace links 228 each generally extend between an abutment link end 250 and a rearward link mount 252, with a forward link mount 254 arranged therebetween. The forward link mounts 254 are pivotably coupled to the rearward pivot mounts 246 of the connecting links 226 about the link axis LA, such as by one or more fasteners, bushings, bearings, and the like (not shown in detail). The rearward link mounts 252 are each operatively attached to the deployment lock mechanism 164 about a barrel axis BA. The brace links 228 each define a link abutment surface 256 disposed adjacent to the abutment link end 250 which are arranged to abut the link stops 248 of the connecting links 226 in the deployed position 154B (see FIG. 10B). The brace links 228 also define a relief region 258 formed between the forward link mount 254 and the rearward link mount 252. The relief regions 258 are shaped to at least partially accommodate the link stops 248 of the connecting links 226 when the track assemblies 154 are in the retracted position 154A (not shown in detail). The deployment linkage 162, the deployment lock mechanism 164, and the deployment lock release 166 may be similar to as is disclosed by U.S. Patent Publication No. 2021/0196536, the disclosure of which is hereby incorporated by reference in its entirety.

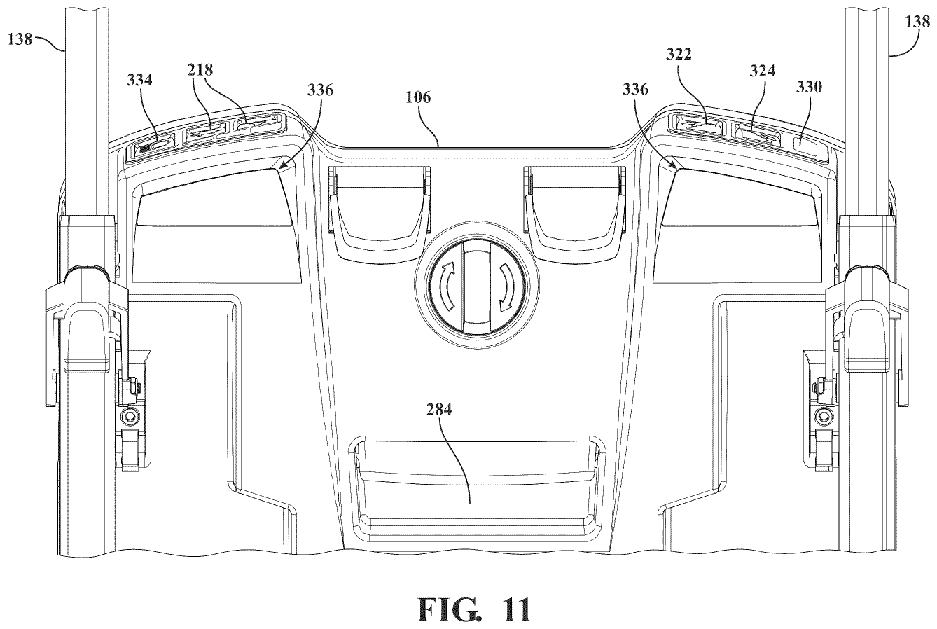

With continued reference to FIGS. 10A-10B and additional reference to FIG. 11, the patient transport apparatus 100 employs a folding lock mechanism 284 to facilitate changing between the stowed configuration FC (see FIG. 8) and the chair configuration CC (see FIG. 9A). To this end, the folding lock mechanism 284 generally comprises a folding lock release 286 operatively attached to the back section 106 and arranged for engagement by the caregiver to releasably secure the folding lock mechanism 284 between a stow lock configuration to maintain the stowed configuration FC, and a use lock configuration to prevent movement to the stowed configuration FC from the chair configuration CC or from the stair configuration SC. The folding lock mechanism 284 may incorporate features as disclosed in U.S. Pat. No. 6,648,343 previously incorporated by reference and as disclosed in U.S. Patent Publication No. 2021/0196536, previously incorporated by reference.

The drive system 182 may include various components not specifically illustrated or be configured in various ways not discussed in detail but described in U.S. Patent Publication No. 2021/0196536, previously referenced and incorporated by reference. In a version, the motor 188 may be supported on an adjustable platform that is movable relative to the drive frame 184 to adjust slack in the endless chain. This arrangement helps to optimize power density and minimize weight in the drive system 182. It will be appreciated that this arrangement could be utilized with other types of geartrains 192, such as where a belt drive (not shown) would replace the endless chain 198. Other configurations are contemplated.

In some versions, the geartrain 192 may be configured with a direct drive gearbox coupled to one of the rails 168 of the track assembly 154. Here, the drive axle 190 extends through the direct drive gearbox, and the motor 188 may be coupled to the direct drive gearbox. In some versions, the patient transport apparatus 100 may include a “passive brake” that allows the speed of the patient transport apparatus 100 to be controlled when on stairs ST even when the battery 206 is of low charge, dead, or not connected to the drive system 182 (e.g., inadvertently removed).

FIGS. 12A-12F successively depict exemplary steps of transporting a patient supported on the patient transport apparatus 100 down the stairs ST. In FIG. 12A, a first caregiver is shown engaging the pivoting handle assemblies 130 in the engagement position 130B to illustrate approaching stairs ST while the patient transport apparatus 100 is moved along floor surfaces FS in the chair configuration CC. In FIG. 12B, the patient transport apparatus 100 has been moved closer to the stairs with a second caregiver engaging the front handle assemblies 128 after having moved them to the extended position 128B. The deployment lock release 166 was also deployed by the first caregiver to move the patient transport apparatus 100 into the stair configuration SC as shown. As shown in the stair configuration SC, the track assemblies 154 are arranged in the deployed position 154B. Here, the rear wheels 152 are positioned significantly closer to the front wheels 122 compared to operation in the chair configuration CC, and are also arranged further under the seat section 104. It will be appreciated that transitioning the patient transport apparatus 100 from the chair configuration CC to the stair configuration SC has resulted in minimal patient movement relative to the support structure 102 as the carrier assembly 148 pivots about the hub axis HA and moves the rear wheels 152 closer to the front wheels 122 in response to movement of the track assemblies 154 to the deployed position 154B.

Furthermore, while the arrangement of the patient's center of gravity has not changed significantly relative to the support structure 102, the longitudinal distance which extends between the patient's center of gravity and the location at which the rear wheels 152 contact the floor surface FS has shortened considerably. Because of this, the process of “tilting” the patient transport apparatus 100 (e.g., about the rear wheels 152) to transition toward contact between the track assemblies 154 and the stairs ST, as depicted in FIG. 12C, is significantly more comfortable for the patient than would otherwise be the case if the patient transport apparatus 100 were “tilted” about the rear wheels 152 from the chair configuration CC (e.g., with the rear wheels 152 positioned further away from the front wheels 122). Put differently, the arrangement depicted in FIG. 12C is such that the patient is much less likely to feel uncomfortable, unstable, or as if they are “falling backwards” during the “tilting” process. Here too, the caregivers are afforded with similar advantages in handling the patient transport apparatus 100, as the arrangement of the rear wheel 152 described above also makes the “tilting” process easier to control and execute. In FIG. 12D, the caregivers are shown continuing to support the patient transport apparatus 100 in the stair configuration SC as the belts 156 of the track assemblies 154 are brought into contact with the edge of the top stair ST.

In FIGS. 12E and 12F, the caregivers are shown continuing to support the patient transport apparatus 100 in the stair configuration SC as the belts 156 of the track assemblies 154 contact multiple stairs ST during descent

The patient transport apparatus 100 is configured to operate in a variety of states and modes in certain versions, including for example in or between one or more inactive states SI and/or one or more active states SA. During the inactive state SI, power consumption of the patient transport apparatus 100 is limited as the motor is not controlling movement of the belt during this state, and during the active state SA the controller 212 may be utilized to control movement of the belt 156 with the motor 188 of the patient transport apparatus 100.

It will be appreciated that the controller 212 may be configured to operate in a variety of inactive states SI and active states SA. The controller 212 may be configured to operate in (or between) a sleep mode MS of the inactive state SI and an active mode MS of the inactive state SI. The controller 212 may also operate in a variety of inactive states, for example, a low charge mode MLC of the inactive state SI, and/or a battery disconnect mode MBD of the inactive state SI which are discussed in detail in U.S. Patent Publication No. 2021/0196539, the disclosure of which is hereby incorporated by reference in its entirety.

During the sleep mode MS of the inactive state SI, power consumption of the patient transport apparatus 100 is limited. In some versions, power consumption of the patient transport apparatus 100 may be limited by only allowing the controller 212 to provide power from the battery 206 to certain components of the patient transport apparatus 100. For example, during the sleep mode MS, the controller 212 may be unable to generate and transmit control signals to some of the one or more powered devices, or components thereof, to drive the patient transport apparatus 100. Here, however, the controller 212 may be configured to provide power to the user interface 204. In the sleep mode MS, the user interface 204 may be prevented from emitting light, but may be configured to receive input generate by user engagement of any portion of the user interface 204. Additionally, in some instances of the sleep mode MS, one or more of the controller 212, the motor 188, the geartrain 192, and/or the track assemblies 154 may also be configured to “brake” or otherwise prevent movement of the belts 156.

During active mode MA of the inactive state, the controller 212 may not limit power consumption of any component of the patient transport apparatus 100. For example, the user interface 204 may emit light for a predetermined period of time in response to user engagement of one of the input controls 214, 216, 218, 222, 224, 322, 324, 326, 328, and 334. Various other components of the patient transport apparatus 100 may be provided power upon demand without limitation during the active mode MA of the inactive state SI.

The controller 212 may be configured to operate in a drive mode MD during the active state SA to control a direction of movement of the belt 156. In some versions, the controller 212 may be configured to additionally operate in additional modes to the drive mode during the active state SA such as a hold mode MH of the active state SA for limiting movement of the belt 156 to facilitate a controlled descent of the patient transport apparatus 100 along stairs ST. The hold mode is disclosed by the discussed in detail in U.S. Patent Publication No. 2021/0196539, previously incorporated by reference.

In some versions, the user interface 204 may comprise one or more light modules 210 realized as backlight modules 336 arranged to illuminate various input controls 214, 216, 218, 222, 224, 322, 324, 326, 328, 334 and/or indicators 220, 330, 332 under certain operating conditions. In some versions, the user interface 204 may comprise one or more light modules 210 configured to, among other things, provide status information to the caregiver.

In the representative version illustrated herein, the controller 212 may be operable in sleep mode in which power consumption is limited, and the active mode SA in which power consumption is not limited such as when the controller 212 controls movement of the belt 156 with the motor 188 of the patient transport apparatus 100. As previously described, the controller 212 may be configured to operate in a variety of other modes/states not explicitly discussed herewith but discussed in greater detail in U.S. Patent Publication No. 2021/0196539, previously incorporated by reference.

As noted above, the direction input controls 216 may include the first direction input control 322 and the second direction input control 324. Here, the first direction input control 322 may be configured to select a drive direction of the motor 188 in order to ascend stairs. The second direction input control 324 may be configured to select a drive direction of the motor 188 in order to descend stairs.

The one or more speed input controls 218 may be configured to select between the plurality of drive speeds DS1, DS2, DS3 of the motor 188. The speed indicator 332 may be disposed adjacent to the one or more speed input controls 218. The speed indicator 332 may be configured to display the selected one of the plurality of drive speeds DS1, DS2, DS3 of the motor 188 to the user.

The plurality of drive speeds DS1, DS2, DS3 may correspond to predetermined speed settings (a specific RPM setting) stored in memory of the controller 212. The plurality of drive speeds DS1, DS2, DS3 may include a first drive speed DS1, a second drive speed DS2, and a third drive speed DS3. The first drive speed DS1 corresponds to the lowest of the plurality of drive speeds DS1, DS2, DS3. The third drive speed DS3 corresponds to the highest drive speed of the plurality of drive speeds DS1, DS2, DS3. The second drive speed DS2 corresponds to a speed in between the first drive speed DS1 and the third drive speed DS3. It will be appreciated that the forgoing are non-limiting, illustrative examples of three discreet drive speeds, and other configurations are contemplated, including without limitation additional and/or fewer drive speeds, drive speeds defined in other ways, and the like.

As noted above, the one or more speed input controls 218 may include a first speed input control 326 and a second speed input control 328. The controller 212 may be configured to increase the selected speed to the next higher drive speed setting in response to the user engagement of the first speed input control 326. For example, in response to receiving user input generated by user engagement of the first speed input control 326 when the current selected drive speed is the first drive speed DS1, the controller 212 may set the current speed to the second drive speed DS2. The controller 212 may be configured to decrease the selected drive speed to the next lower drive speed setting in response to user engagement of the second speed input control 328. For example, when the current selected drive speed is the second drive speed DS2, the controller 212 may set the current speed to the first drive speed DS1 in response to user engagement of the second speed input control 328.

In some versions, the controller 212 may be configured to initially select the first drive speed DS1 of the plurality of drive speeds DS1, DS2, DS3 in response to user engagement of the direction input controls 216 following the change in operation from the inactive state SI to the active state SA. However, it is contemplated that the controller 212 may be configured alternatively, such as to initially select the second drive speed DS2 or the third drive speed DS3 of the plurality of drive speeds DS1, DS2, DS3.

The controller 212 may be configured to selectively permit operation of the motor 188 in response to receiving user input generated by engagement of one of the activation input controls 214 (e.g., the first activation input control 222 or the second activation input control 224). For example, the controller 212 may be configured to permit operation of the motor 188 in response to user engagement of at least one of the activation input controls 214 following user engagement of the direction input control 216 to drive the belt 156 in a selected drive direction. In another example, the controller 212 may be configured to permit operation of the motor 188 in response to user engagement of the activation input controls 214 within a predetermined period following engagement of the direction input control 216. After the predetermined period following user engagement of the direction input control 216 has elapsed, the controller 212 may prevent operation of the motor 188 even when one of the activation input controls 214 is engaged. The controller 212 may also be configured to limit operation of the motor 188 in response to receiving the user input before receiving the user input generated by user selection of one of the direction input controls 216.

With renewed reference to FIGS. 1A-1E, as noted above, the loading device 98 of the system 96 is configured to engage the patient transport apparatus 100 in the stowed configuration FC for loading and unloading onto the transport vehicle VEH. To this end, the loading device 98 generally includes a mount 338, a stage 340, a receiver 342, a dock 344, and an elevating mechanism 346. The mount 338 is configured for mounting to the transport vehicle VEH as described in greater detail below. The stage 340 is operatively attached to the mount 338, and the receiver 342 is arranged for translational movement relative to the stage 340 between a lowered position 342L (see FIGS. 1B-1D; see also FIGS. 2C and 3A-3B) and a raised position 342R (see FIGS. 1A and 1E; see also FIGS. 2A-2B and 3C-3D). The dock 344 is operatively attached to the receiver 342 and is configured for engagement with the support structure 102 of the patient transport apparatus 100. In the illustrated versions, the dock 344 helps support the patient transport apparatus 100 in spaced relation from the ground or floor surface FS during loading and unloading.

The elevating mechanism 346 is operably coupled between the stage 340 and the receiver 342 and is operable between a first mode 346A (see FIGS. 1A-1C) and a second mode 346B (see FIGS. 1D-1E). The first mode 346A is associated with operation of the elevating mechanism 346 which occurs when the patient transport apparatus 100 is spaced away from the dock 344 (e.g., not supported), and is defined with a first lifting force F1 acting on the receiver 342 to move the receiver 342 from the lowered position 342L (see FIG. 1B) towards the raised position 342R (see FIG. 1A). The second mode 346B is associated with operation of the elevating mechanism 346 which occurs when the patient transport apparatus 100 is secured to the dock 344, and is defined with a second lifting force F2, greater than the first lifting force F1, acting on the receiver 342 to move the receiver 342 from the lowered position 342L (see FIG. 1D) towards the raised position 342R (see FIG. 1E) for moving the receiver 342 and the patient transport apparatus 100 loaded onto the dock 344 into a secured configuration CS for transit with the transport vehicle VEH. The various components of the loading device 98 introduced above will each be described in greater detail below.

As will be appreciated from the subsequent description below, the configuration of the elevating mechanism 346 disclosed herein affords balancing the weight of both the patient transport apparatus 100 and the components coupled to the receiver 342 such that a caregiver can lift and lower the patient transport apparatus 100 secured to the receiver 342 without necessitating an excessive application of external force during operation in the second mode 346B, and while also ensuring that the receiver 342 can easily be moved during operation in the first mode 346A whereby the first lifting force F1 is balanced against the weight of the unloaded receiver 342 and the components coupled thereto. Put differently, this configuration helps ensure that the caregiver can easily move the receiver 342 between the lowered position 342L and the raised position 342R during operation in the first mode 346A with the patient transport apparatus 100 unloaded, and during operation in the second mode 346B with the patient transport apparatus 100 loaded. It will be appreciated that the ability to change operation between the first mode 346A and the second mode 346B affords significant advantages relating to consistent usability and force application in that excessive external force does not need to be applied by a caregiver to lift the receiver 342 from the lowered position 342L when loaded with the patient transport apparatus 100, nor does excessive external force need to be applied by a caregiver to lower the receiver 342 from the raised position 342R when the patient transport apparatus 100 is not loaded.

The elevating mechanism 346 generally includes a loading subassembly 348 operatively attached to one of the stage 340 and the receiver 342, and an interface coupling 350 operatively attached to the other of the stage 340 and the receiver 342 and disposed in force-translating communication with the loading subassembly 348. In the representative versions illustrated herein, the loading subassembly 348 is operatively attached to the stage 340, and the interface coupling 350 is operatively attached to the receiver 342. The loading subassembly 348 and the interface coupling 350 will each be described in greater detail below.

As shown in FIGS. 1A-1E, the loading device 98 is operable between the secured configuration CS (see FIGS. 1A and 1E) defined with the receiver 342 arranged in the raised position 342R to facilitate transit of the transport vehicle VEH (with or without the loaded patient transport apparatus 100), and an access configuration CA (see FIGS. 1B-1D) defined with the receiver 342 arranged in the lowered position 342L to facilitate loading and unloading the patient transport apparatus 100 relative to the dock 344.

In the representative versions illustrated throughout the drawings, the loading device 98 includes a limiter 352 interposed between the stage 340 and the receiver 342 to inhibit movement of the receiver 342 relative to the stage 340 in a plurality of degrees of freedom. As is described in greater detail below, the limiter 352 helps ensure that the receiver 342 remains stable and secure relative to the transport vehicle VEH when the receiver 342 is being moved relative to the stage 340 between the lowered position 342L and the raised position 342R, when the receiver 342 is being moved relative to the transport vehicle VEH in another direction (e.g., as is described in greater detail below in connection with FIGS. 2A-3D), as well as when the patient transport apparatus 100 is being loaded onto and/or unloaded from the dock 344.

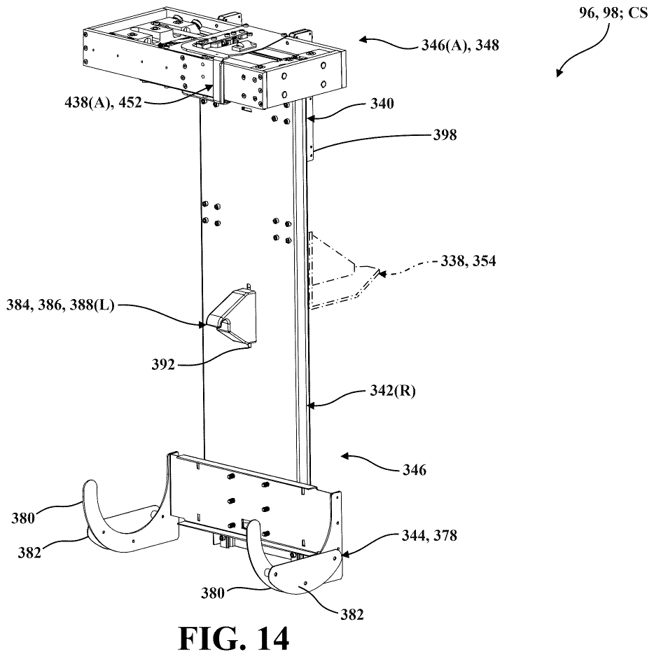

As noted above, the stage 340 of the loading device 98 is operatively attached to the mount 338 which, in turn, facilitates mounting the loading device 98 to the transport vehicle VEH. In some versions, such as the version depicted in FIG. 14, the mount 338 may be configured as an angled bracket 354 which is operatively attached to the stage 340 and to a surface within the cargo volume VC or the interior volume VI of the transport vehicle VEH that is arranged at an angle (e.g., 90-degrees) relative to the stage 340. For example, the angled bracket 354 may be attached to a floor surface of the transport vehicle VEH. Those having ordinary skill in the art will appreciate that the mount 338 may be operatively attached to the vehicle VEH and/or to the stage 340 in a number of different ways without departing from the scope of the present disclosure, including without limitation via fasteners such as bolts, nuts, screws, rivets, and the like, as well as in other ways such as by welding. Other configurations are contemplated.

In some versions, rather than the mount 338 including or otherwise being realized as the angled bracket 354, the mount 338 could instead be configured to facilitate mounting to a surface of the transport vehicle VEH that is arranged generally parallel to the stage 340, such as to facilitate mounting the stage 340 to the door DR of the transport vehicle VEH as described above. In some versions, the stage 340 could include or otherwise define the mount 338, such as with apertures formed through the stage 340 to receive fasteners used to secure the stage 340 to the door DR or another component of the transport vehicle VEH. In some versions, the loading device 98 may include one or more additional components interposed between the transport vehicle VEH and the mount 338 and/or interposed between the mount 338 and the stage 340, including for example different arrangements of brackets, fasteners, actuators, linkages, and the like.

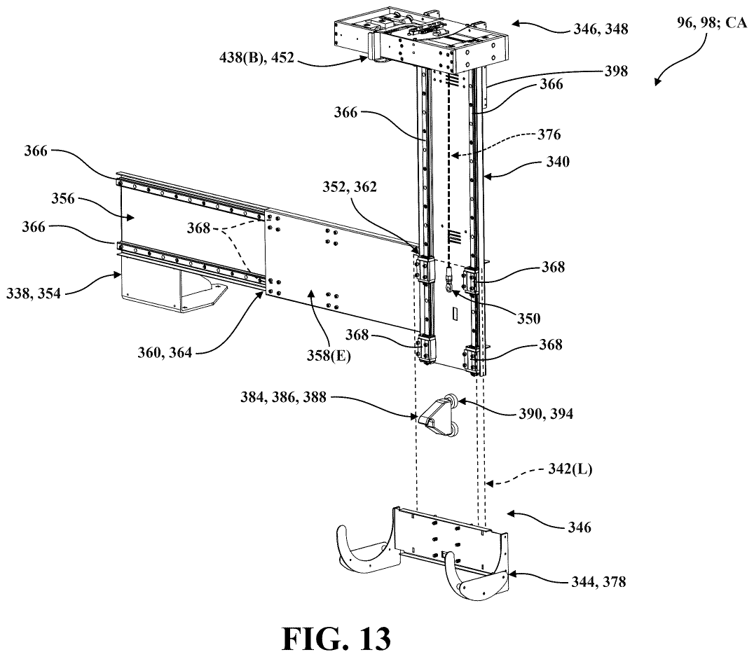

In some versions, such as the version depicted in FIGS. 2A-3D and FIG. 13, the loading device 98 may include a second stage 356 operatively attached to the mount 338, a second receiver 358 supporting the stage 340 and arranged for translational movement relative to the second stage 356 between a retracted position 358R (see FIGS. 2A and 3D) and an extended position 358E (see FIGS. 2B-2C, 3A-3C, and 13), and a second limiter 360 (see FIG. 13) interposed between the second stage 356 and the second receiver 358 to inhibit movement of the second receiver 358 relative to the second stage 356 in a second plurality of degrees of freedom. As is illustrated by sequentially viewing FIGS. 2A-3D, the second stage 356 is coupled to the mount 338 in the illustrated version, such as with one or more fasteners (not shown in detail), and supports the stage 340 for concurrent movement with the second receiver 358 relative to the mount 338 between the retracted position 358R (see FIGS. 2A and 3D) and the extended position 358E (see FIGS. 2B-2C and 3A-3C). Here too, it will be appreciated that the stage 340 could be coupled to the second receiver 358, either directly or indirectly, in a number of different ways without departing from the scope of the present disclosure.

In the version depicted in FIGS. 2A-3D and 13, the limiter 352 is configured to inhibit lateral and longitudinal movement of the receiver 342 relative to the stage 340, and the second limiter 360 is configured to inhibit vertical and longitudinal movement of the second receiver 358 relative to the second stage 356. Put differently, in this version, movement of the receiver 342 relative to the stage 340 between the lowered position 342L (see FIGS. 2C and 3A-3B) and the raised position 342R (see FIGS. 2A-2B and 3C-3D) occurs in the vertical direction and the limiter 352 is configured to permit vertical movement of the receiver 342 relative to the stage 340 but to inhibit movement of the receiver 342 relative to the stage 340 in directions transverse to the vertical direction, and movement of the second receiver 358 relative to the second stage 356 between the retracted position 358R (see FIGS. 2A and 3D) and the extended position 358E (see FIGS. 2B-2C and 3A-3C) occurs in the horizontal direction (e.g., laterally, longitudinally, or otherwise transverse to the vertical direction) and the second limiter 360 is configured to permit horizontal movement of the second receiver 358 relative to the second stage 356 but to inhibit movement of the second receiver 358 relative to the second stage 356 in directions transverse to the horizontal direction.

As is best depicted in FIG. 13, the limiter 352 includes a linear slide assembly 362 supporting the receiver 342 for sliding movement relative to the stage 340 between the lowered position 342L and the raised position 342R. Similarly, the second limiter 360 includes a second linear slide assembly 364 supporting the second receiver 358 for sliding movement relative to the second stage 356 between the retracted position 358R and the extended position 358E. In the representative version illustrated in FIG. 13, the linear slide assemblies 362, 364 each include respective pairs of rails 366 which each slidably support a corresponding set of blocks 368 to facilitate sliding movement in a specific direction but to inhibit or otherwise substantially prevent movement in directions transverse to that specific direction. Put differently, the rails 366 and the blocks 368 of the linear slide assembly 362 inhibit movement of the receiver 342 relative to the stage 340 in four degrees of freedom (lateral and longitudinal translation, and lateral and longitudinal rotation), and the rails 366 of the blocks 368 of the second linear slide assembly 364 inhibit movement of the second receiver 358 relative to the second stage 356 in four degrees of freedom (vertical and longitudinal translation, and vertical and longitudinal rotation).

The rails 366 of the linear slide assembly 362 are operatively attached the stage 340 and each supports a corresponding set of two blocks 368 which are operatively attached to the receiver 342, and the rails 366 of the second linear slide assembly 364 are operatively attached to the second stage 356 and each supports a corresponding set of two blocks 368 which are operatively attached to the second receiver 358. In the illustrated versions, fasteners (not shown in detail) are utilized facilitate operative attachment of the linear slide assemblies 362, 364 between the stages 340, 356 and the receivers 342, 358. However, it will be appreciated that other configurations are contemplated, and the linear slide assemblies 362, 364 could be operatively attached to or otherwise formed integrally with various components of the loading device 98.

Those having ordinary skill in the art will appreciate that the limiters 352, 360 could be configured in various ways to limit movement of their associated receivers 342, 358 relative to the corresponding stages 340, 356. In some versions, the limiters 352, 360 could be configured differently from each other, such as to limit different quantities of degrees of freedom (e.g., with the second limiter 360 configured to permit lateral rotation). In some versions, different quantities of rails 366 and/or blocks 368 could be employed, such as with each limiter 352, 360 utilizing a single rail 366 and/or fewer or more blocks 368 for each rail 366. In some versions, the arrangement of the rails 366 and the blocks 368 could be interposed (e.g., with the rails 366 coupled to the receivers 342, 358 rather than to the stages 340, 356). Other configurations are contemplated.

In the version depicted in FIGS. 2A-3D, the secured configuration CS (see FIGS. 2A and 3D) is defined with the receiver 342 arranged in the raised position 342R and with the second receiver 358 arranged in the retracted position 358R to facilitate transit of the transport vehicle VEH (with or without the loaded patient transport apparatus 100), and the access configuration CA (see FIGS. 2C-3B) is defined with the receiver 342 arranged in the lowered position 342L and with the second receiver 358 arranged in the extended position 358E to facilitate loading and unloading the patient transport apparatus 100 relative to the dock 344. Here in this version, loading device 98 is also operable in one or more intermediate configurations CI (see FIGS. 2B and 3C) between the secured configuration CS and the access configuration CA defined with the receiver 342 arranged in the raised position 342R and with the second receiver 358 arranged in the extended position 358E.

As shown in FIGS. 1A-3D, in some versions, the loading device 98 includes a stage lock 370 interposed between the stage 340 and the receiver 342 to selectively inhibit movement of the receiver 342 relative to the stage 340 between the lowered position 342L and the raised position 342R. As shown in FIGS. 2A-3D, in some versions, the loading device 98 includes a second stage lock 372 interposed between the second stage 356 and the second receiver 358 to selectively inhibit movement of the second receiver 358 relative to the second stage 356 between the retracted position 358R and the extended position 358E.

In some versions, the stage lock 370 is configured to maintain the receiver 342 in the raised position 342R, such as to prevent inadvertent movement of the receiver 342 relative to the stage 340 until a caregiver selectively engages the stage lock 370 and subsequently moves the receiver 342 to the lowered position 342L. However, it will be appreciated that other configurations are contemplated, and the stage lock 370 could alternatively or additionally be configured to maintain the receiver 342 in the lowered position 342L and/or in one or more intermediate positions (not shown) between the raised position 342R and the lowered position 342R, such as to define multiple adjacent lowered positions 342L of the receiver 342 to allow the caregiver to load or unload the patient transport apparatus 100 at different heights relative to ground or floor surfaces FS. In some versions, the second stage lock 372 is configured to maintain the second receiver 342 in the retracted position 342R, such as to prevent inadvertent movement of the receiver 358 relative to the second stage 356 (e.g., in scenarios where the transport vehicle VEH is parked on an incline) until a caregiver selectively engages the second stage lock 372 and subsequently moves the second receiver 358 to the extended position 358E. However, it will be appreciated that other configurations are contemplated, and the second stage lock 372 could alternatively or additionally be configured to maintain the second receiver 358 in the extended position 358E and/or in one or more intermediate positions (not shown) between the retracted position 358R and the extended position 358E, such as to define multiple adjacent extended positions 358E of the second receiver 358 to allow the caregiver to load or unload the patient transport apparatus 100 at horizontal positions relative to the transport vehicle VEH.

As shown in FIGS. 1A-3C, the stage lock 370 and/or the second stage lock 372 may be realized or otherwise include flanges 374 that are operatively attached to corresponding spring-loaded detent plungers (not shown in detail) which, in turn, are coupled to the respective receivers 342, 358 for concurrent movement with the receivers 342, 358 relative to their associated stages 340, 356, whereby one or more apertures (not shown) may be formed in or otherwise defined by the stages 340, 356 that are shaped to receive the detent plungers of the stage locks 370, 372. With this configuration, the detent plungers of the stage locks 370, 372 automatically engage the apertures of the stages 340, 356 and inhibit movement of the receivers 342, 358 until the caregiver selectively engages the flanges 374 of the stage locks 370, 372 to enable movement of the receivers 342, 358. In some versions, the stage locks 370, 372 may be configured to remain biased for engagement with apertures in the stages 340, 356, may be configured to be placed in released states (not shown) to allow free movement of the receivers 342, 358, or may be configured to be placed into a temporary released state (not shown) to allow free movement away from an engaged aperture before becoming biased for engagement with a different aperture. Other configurations are contemplated, and those having ordinary skill in the art will appreciate that the stage locks 370, 372 could be realized in a number of different ways, with different arrangements of components and/or structural features formed on the receivers 342, 358, the stages 340, 356, and/or other components of the loading device 98. In some versions, the loading device 98 may employ electronically-actuated stage locks 370, 372. In some versions, multiple stage locks 370, 372 may be utilized for a single stage 340, 356. In some versions, one of the stages 340, 356 may employ a stage lock 370, 372 while the other stage 340, 356 may omit a stage lock 370, 372. Other configurations are contemplated.

As noted above, the elevating mechanism 346 generally includes the loading subassembly 348 operatively attached to the stage 340, and the interface coupling 350 operatively attached to the receiver 342 and disposed in force-translating communication with the loading subassembly 348. To this end, in the illustrated version, the elevating mechanism 346 also includes a flexible tension element 376 which is operably coupled to the interface coupling 350 and to the loading subassembly 348 which, as described in greater detail below, is configured to shorten an effective length of the flexible tension element 376 between the receiver 342 and the stage 340 for moving the receiver 342 between the lowered position 342L (see FIGS. 1B-1D and 2C-3B) to the raised position 342R (see FIGS. 1A, 1E, 2A-2B, and 3C-3D).

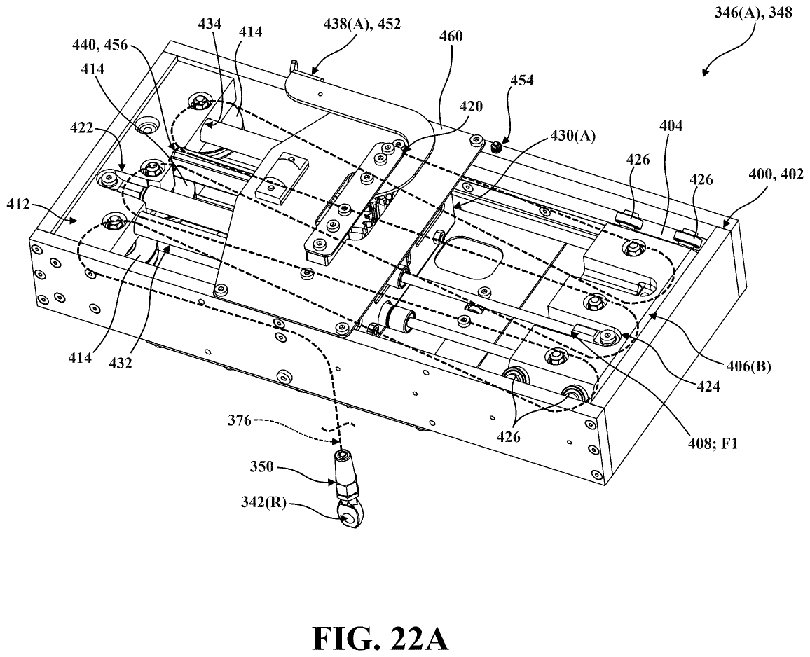

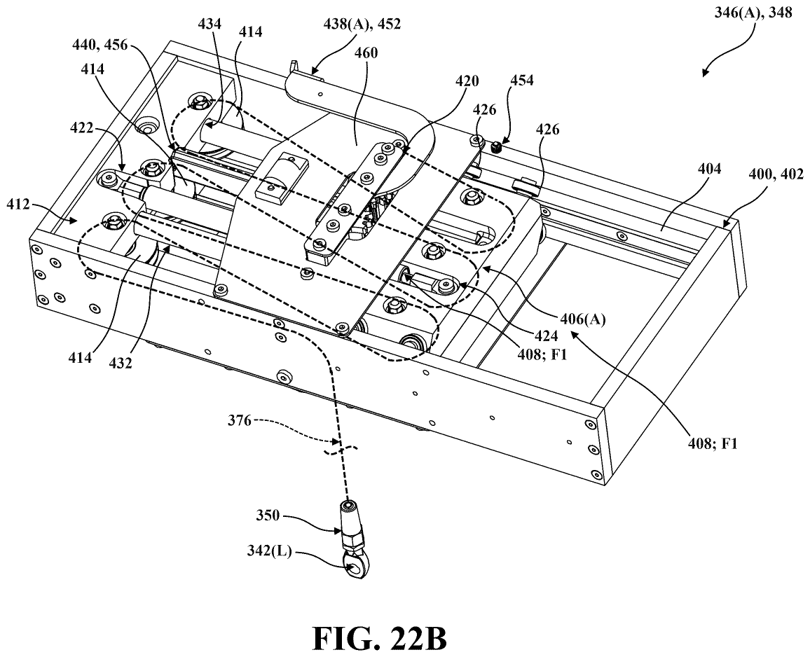

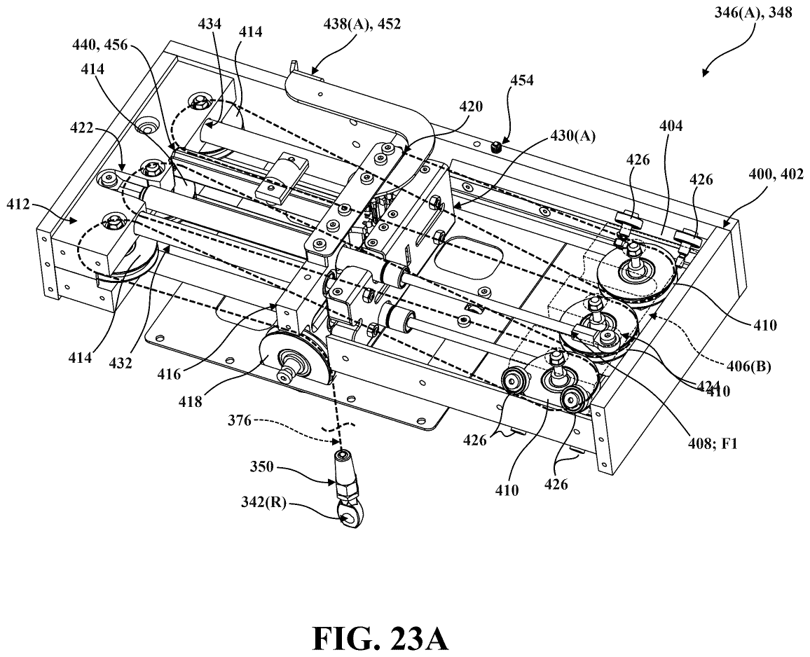

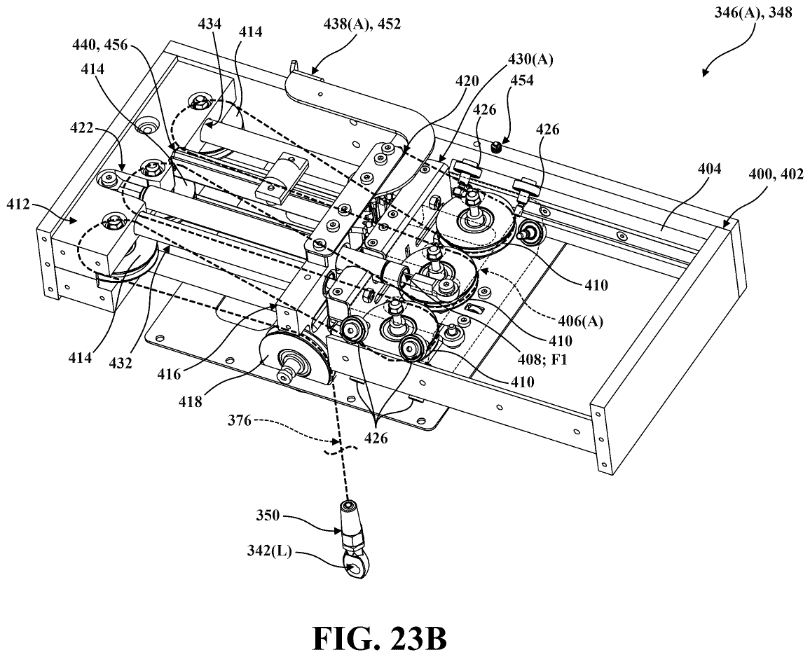

While not depicted in detail throughout the drawings, the flexible tension element 376 may be realized as a cable, cord, or similar element which is able to maintain tension while also facilitating routing between one or more pullies, as described in greater detail below. In some versions, the flexible tension element 376 may be constructed as a rope, cable, cord, and the like manufactured from one or more strands of steel, stainless steel, ultra-high-molecular-weight (UHMW) polyethylene, nylon, polyester and the like. In some versions, the flexible tension element 376 may be a laminated composite material. In some versions, the flexible tension element 376 may be braided or twisted to form a flat strap, webbing, or a round rope. In some versions, the flexible tension element 376 may be implemented in shapes and materials other than those described above. Other configurations are contemplated. The arrangement of the flexible tension element 376 will be described in greater detail below in connection with FIGS. 22A-23B.

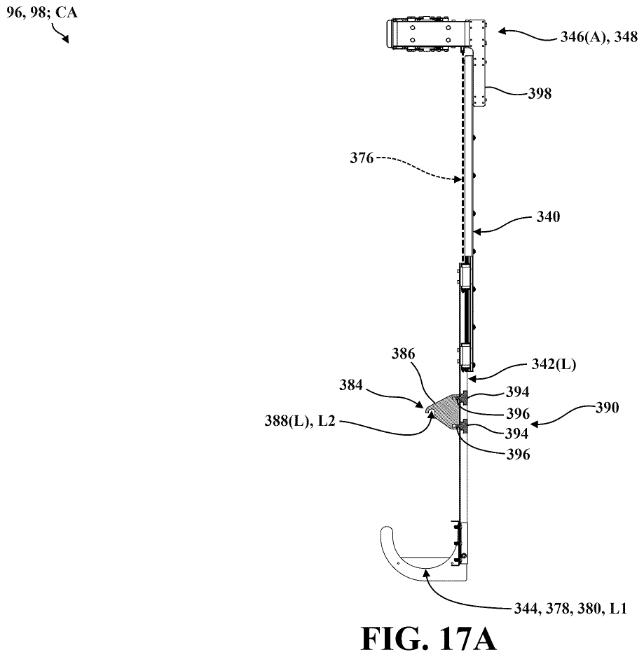

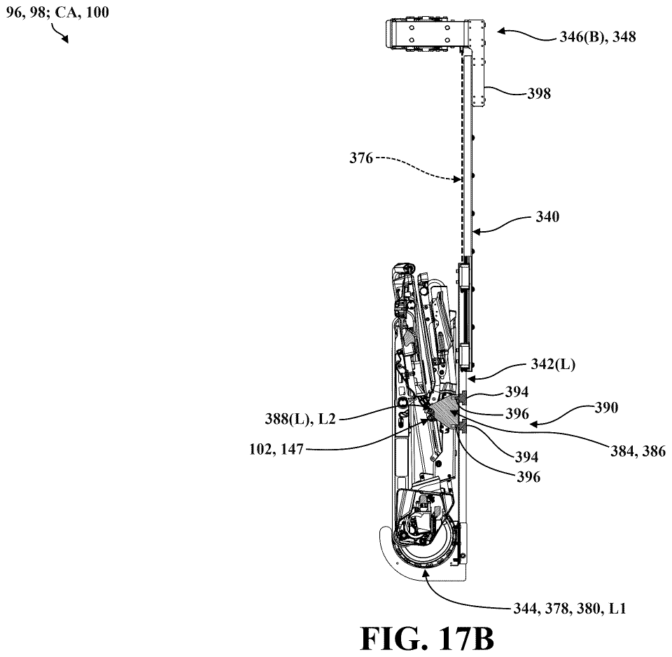

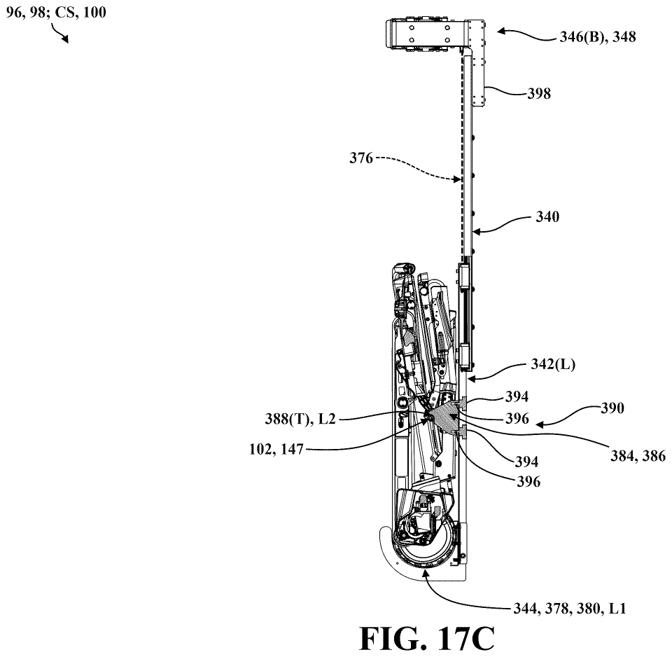

The dock 344 supports the patient transport apparatus 100 during loading and unloading from the loading device 98. In the representative versions depicted throughout the drawings, the dock 344 is arranged adjacent to a lower end of the receiver 342 and is shaped and arranged to support the patient transport apparatus 100 at a first location L1 (see FIG. 17B). Engagement between the dock 344 and the patient transport apparatus 100 occurs in at least one first location L1 to provide support to the patient transport apparatus 100 in the vertical direction relative to the receiver 342, whereby the patient transport apparatus 100 is at least partially supported vertically above the ground or floor surface FS (see FIG. 1C). However, in some versions, it is contemplated that the dock 344 or another portion of the receiver 342 may be disposed in contact with the ground or floor surface FS during operation in the lowered position 342L. Furthermore, in some versions, engagement between the dock 344 and the patient transport apparatus 100 may occur so as to provide support to the patient transport apparatus 100 in other directions relative to the receiver 342, such as to provide lateral or longitudinal stability. As will be appreciated from the subsequent description below, the dock 344 may be configured or realized in various ways, including with one or more chocks 378 that are realized as components which are operatively attached to the receiver 342.

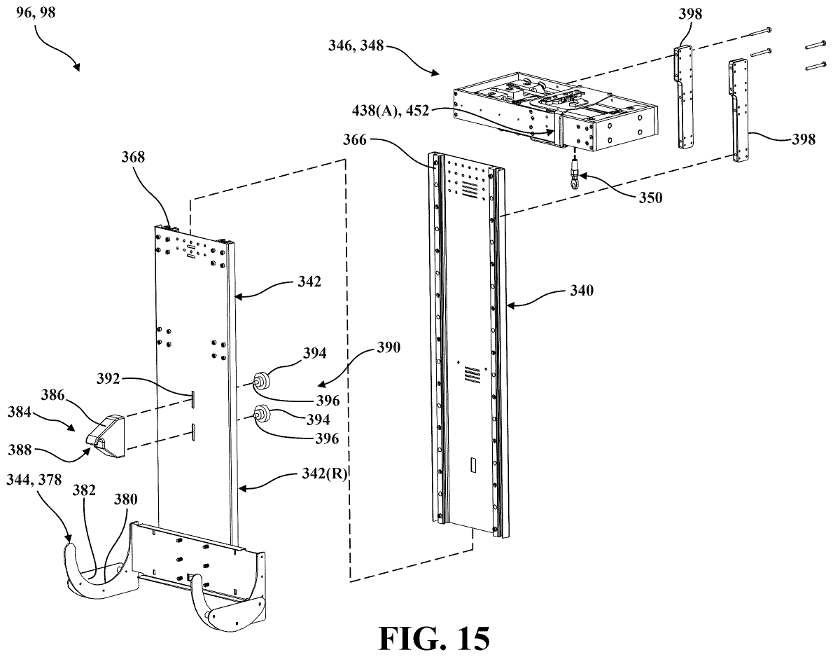

In the version depicted in FIGS. 14-15, the dock 344 includes a pair of chocks 378 operatively attached to the receiver 342, with at least one of the chocks 378 providing support to the patient transport apparatus 100 so as to define the first location L1. The chocks 378 are each shaped to receive a respective one of the rear wheels 152 of the patient transport apparatus 100. In this version, each of the chocks 378 includes a lower chock brace 380 and an outer chock brace 382 (see FIG. 15). The lower chock braces 380 are shaped and arranged to abut the outer surfaces of the respective rear wheels 152 of the patient transport apparatus 100 to provide vertical support, as well as longitudinal support, in the illustrated version during loading and unloading. The outer chock braces 382 are shaped and arranged to abut the lateral surfaces of the respective rear wheels 152 of the patient transport apparatus 100 to provide lateral support in the illustrated during loading and unloading.

The loading device 98 also includes a retainer 384 to releasably secure the patient transport apparatus 100 to the receiver 342. The retainer 384 includes a retainer body 386 operatively attached to the receiver 342, and a catch 388 which is arranged to support the patient transport apparatus 100 at a second location L2 disposed in spaced relation from the first location L1. To this end, the catch 388 of the retainer 384 is shaped to engage the frame element 147 of the support structure 102 of the patient transport apparatus 100 which extends laterally between the uprights 114. Here, the catch 388 has a hooked profile which helps limit movement of the support structure 102 vertically and longitudinally. It will be appreciated that the catch 388 could be configured in various ways to facilitate engaging or otherwise supporting different portions of the support structure 102 (or other components of the patient transport apparatus 100). In the illustrated versions, the second location L2 is spaced vertically above the first location L1, and the loading device 98 includes an adjuster 390 interposed between the receiver 342 and the retainer body 386 to selectively move the catch 388 relative to the receiver 342 between a retained position 388T (see FIG. 17C) to inhibit movement of the patient transport apparatus 100 out of contact with the catch 388 at the second location L2 to prevent unloading of the patient transport apparatus 100 from the receiver 342, and a released position 388L (see FIGS. 17A-17B) to permit movement of the patient transport apparatus 100 relative to the catch 388 to facilitate loading and unloading of the patient transport apparatus 100. In the illustrated versions, the adjuster 390 includes one or more slots 392 defined in the receiver 342, and one or more knobs 394 with shafts 396 extending through the one or more slots 392 between the one or more knobs and the retainer body 386. Here, the shafts 396 are disposed in threaded engagement (not shown in detail) with the retainer body 386 such that user engagement of the knobs 394 changes operation of the retainer 384 between the retained position 388T and the released position 388L, whereby tightening the threaded engagement operates the retainer 384 in the retained position 388T to compress the receiver 342 between the knobs 394 and the retainer body 386, and loosening the threaded engagement operates the retainer 384 in the released position 388L allowing the shafts 396 to be moved along the slots 392 to selectively move the catch 388 relative to the first location L1.

In this version, initial loading of the patient transport apparatus 100 during operation of the loading device 98 in the access configuration CA may be achieved from the arrangement depicted in FIG. 17B by placing the rear wheels 152 into the chocks 378, followed by tilting the patient transport apparatus 100 towards the receiver 342, and then selectively engaging the adjuster 390 to move the catch 388 into engagement with the frame element 147 of the patient transport apparatus 100 as depicted in FIG. 17C before subsequently tightening the knobs 394.

While the illustrated version of the retainer 384 employs the threaded engagement of the shafts 396 to the retainer body 386 as the adjuster 390 to facilitate moving the catch 388, it will be appreciated that the retainer 384 and the adjuster 390 may be configured in various ways to facilitate supporting the patient transport apparatus 100 at the second location L2 to retain the patient transport apparatus 100 relative to the receiver 342. By way of example, the adjuster 390 may utilize various arrangements of catches, pins, locks, shafts, and the like, which may engage with different portions of the patient transport apparatus 100 and may be adjusted manually or automatically (e.g., with spring bias, with powered actuators or solenoids, and the like).

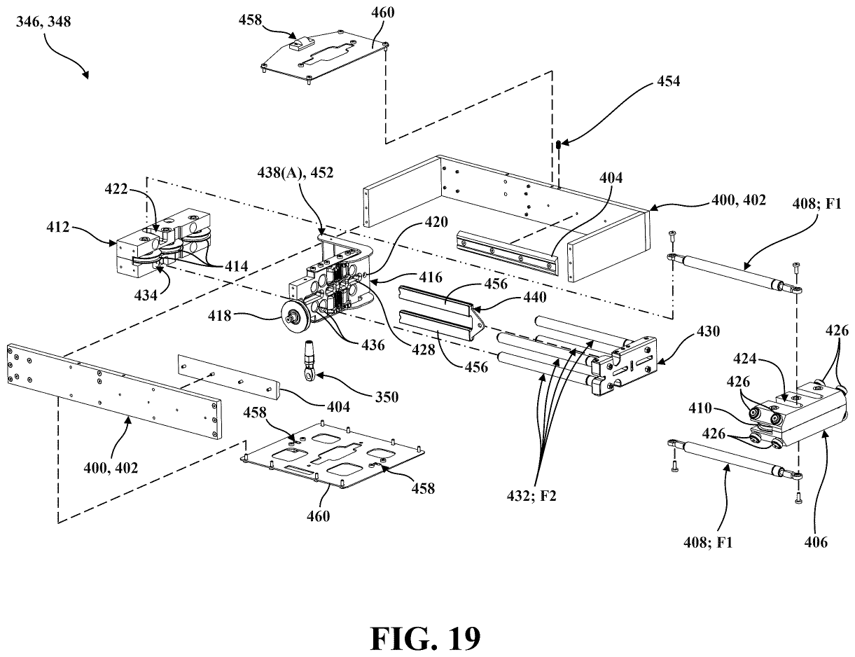

As best shown in FIGS. 14-15, the loading subassembly 348 is operatively attached to the stage 340 by a pair of brackets 398, whereby fasteners (not shown in detail) are employed to facilitate attachment of the brackets 398 to the stage 340 and to a loading frame 400 of the loading subassembly 348. Referring now to FIG. 19, the illustrated loading frame 400 includes four frame walls 402 which are operatively attached together with fasteners (not shown in detail) and support other components of the loading subassembly 348 as described below. However, it will be appreciated that the loading frame 400 could be constructed in other ways, with or without discrete frame walls 402 (e.g., as a unitary component). Other configurations are contemplated.

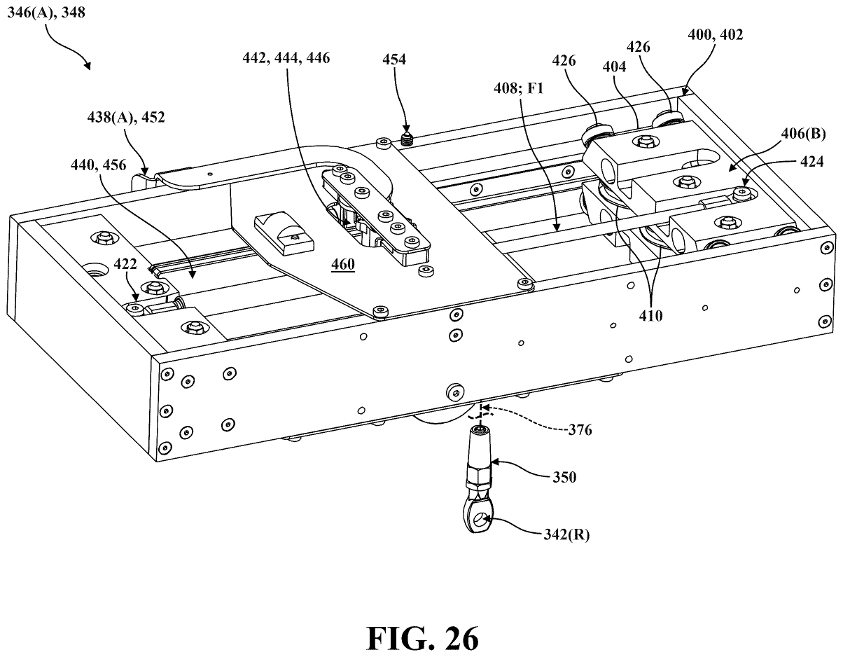

In the illustrated version, the loading subassembly 348 includes a guide track 404 coupled to the loading frame 400, and a carriage 406 disposed in force-translating communication with the interface coupling 350 and supported for sliding movement along the guide track 404 between a first carriage position 406A (see FIGS. 22B, 23B, and 27B-27C) corresponding to the lowered position 342L of the receiver 342, and a second carriage position 406B (see FIGS. 22A, 23A, 25A-27A, and 27E-27F) corresponding to the raised position 342R of the receiver 342. Here, a lift actuator 408 is interposed between the loading frame 400 and the carriage 406 and provides the first lifting force F1 via cooperation with the flexible tension element 376. To this end, the loading subassembly 348 includes one or more carriage pullies 410 operatively attached to the carriage 406 for concurrent movement with the carriage 406 between the first and second carriage positions 406A, 406B, a frame mount 412 operatively attached to the loading frame 400 and supporting one or more frame pullies 414, a routing mount 416 operatively attached to the loading frame 400 and supporting one or more routing pullies 418, and an end mount 420 operatively attached to the loading frame 400, with the flexible tension element 376 routed around the one or more carriage pullies 410, the one or more frame pullies 414, and the one or more routing pullies 418 and extending between the interface coupling 350 (e.g., operatively attached to the receiver 342 such as with one or more fasteners, not shown) and the end mount 420 to translate force between the stage 340 and the receiver 342. In the illustrated version, the loading subassembly 348 includes a total of three carriage pullies 410 and three frame pullies 414, as well as a single routing pully 418. However, other configurations are contemplated.

The frame mount 412 supports the frame pullies 414 for rotation about respective axes via an arrangement of fasteners, bearings, bushings, washers, and the like (not shown in detail). Similarly, the carriage 406 supports the carriage pullies 410 for rotation about respective axes via an arrangement of fasteners, bearings, bushings, washers, and the like (not shown in detail). In the illustrated version, the lift actuator 408 is realized as a pair of gas springs 408 which are each operatively attached to the frame mount 412 and to the carriage 406 via fasteners (not shown in detail). Here, one end of each of the gas springs 408 is seated into a frame notch 422 defined in the frame mount 412, and the other end of each of the gas springs 408 is seated into a carriage notch 424 defined in the carriage 406. The notches 422, 424 are shaped to permit a certain amount of articulation of the gas springs 408, which employ spherical joint ends (not shown in detail) in the illustrated version, as the carriage 406 moves between the first and second carriage positions 406A, 406B. The carriage 406 is supported for sliding movement along the guide track 404 via carriage bearings 426, which are angled in the illustrated version to facilitate retention to the corresponding shape of the guide track 404.

The routing mount 416 supports the routing pulley 418 for rotation about an axis via an arrangement of fasteners, bearings, bushings, washers, and the like (not shown in detail), and defines one or more routing slots 428. The routing pulley 418 is arranged to direct the flexible tension element 376 towards one of the frame pullies 414 which, in turn, routes the flexible tension element 376 through one of the routing slots 428 and towards one of the carriage pullies 410. This arrangement repeats around all of the frame pullies 414 and all of the carriage pullies 410 up to the end mount 420 (see FIGS. 22A-23B; not shown in detail). With this configuration, movement of the receiver 342 relative to the stage 340 between the lowered position 342L and the raised position 342R occurs in the vertical direction, and movement of the carriage 406 along the guide track 404 between the first carriage position 406A and the second carriage position 406B occurs in a direction transverse to the vertical direction. Here too, movement of the carriage 406 from the first carriage position 406A (see FIG. 23B) towards the second carriage position 406B (see FIG. 23A) moves the one or more carriage pullies 410 away from the one or more frame pullies 414.

It will be appreciated that movement of the carriage 406 occurring in a direction transverse to the vertical direction of movement of the receiver 342 between the lowered position 342L to the raised position 342R affords significant opportunities relating to the packaging size of the loading device 98 in that, for example, the overall vertical height of the loading device 98 is optimized based on how the carriage 406 and other components of the loading subassembly 348 are situated while still enabling a significant amount of vertical movement of the receiver 342.

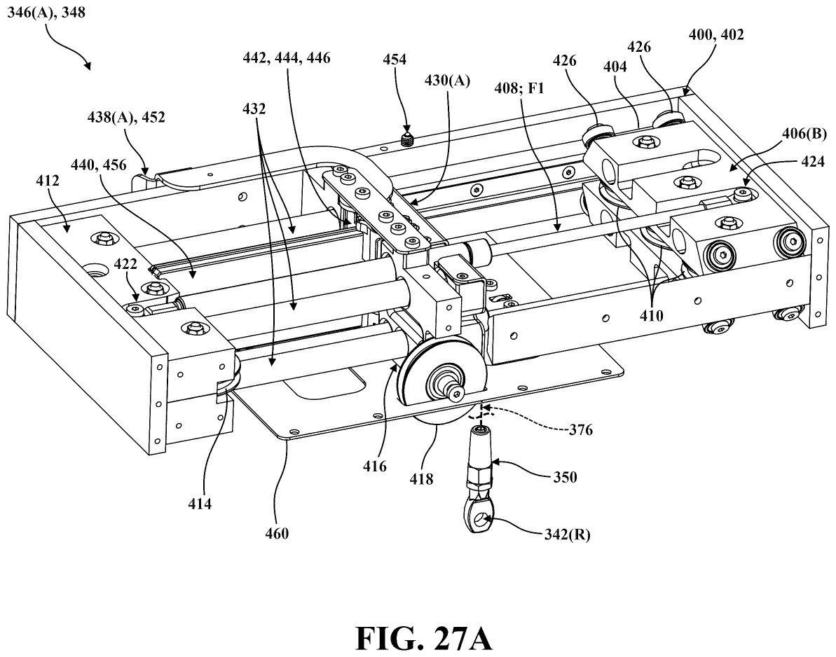

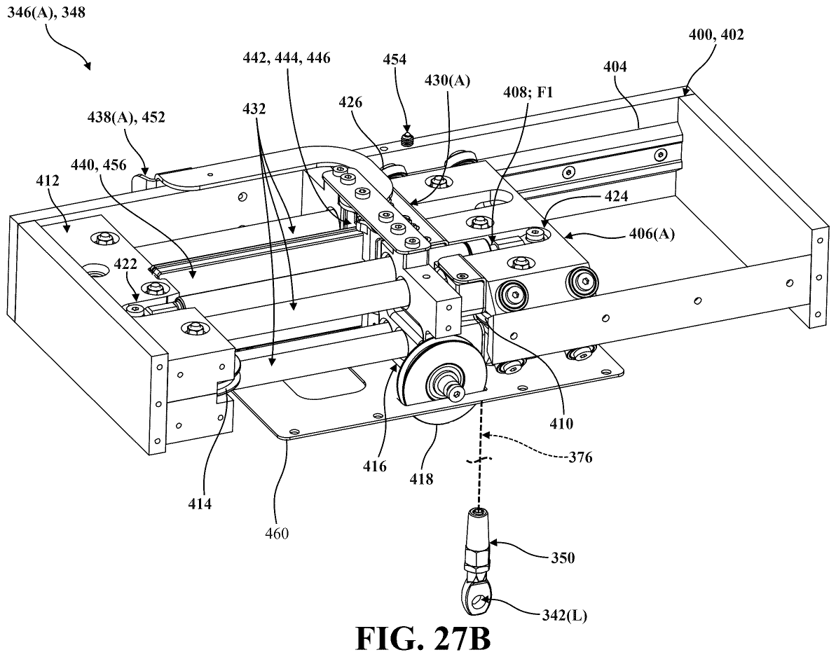

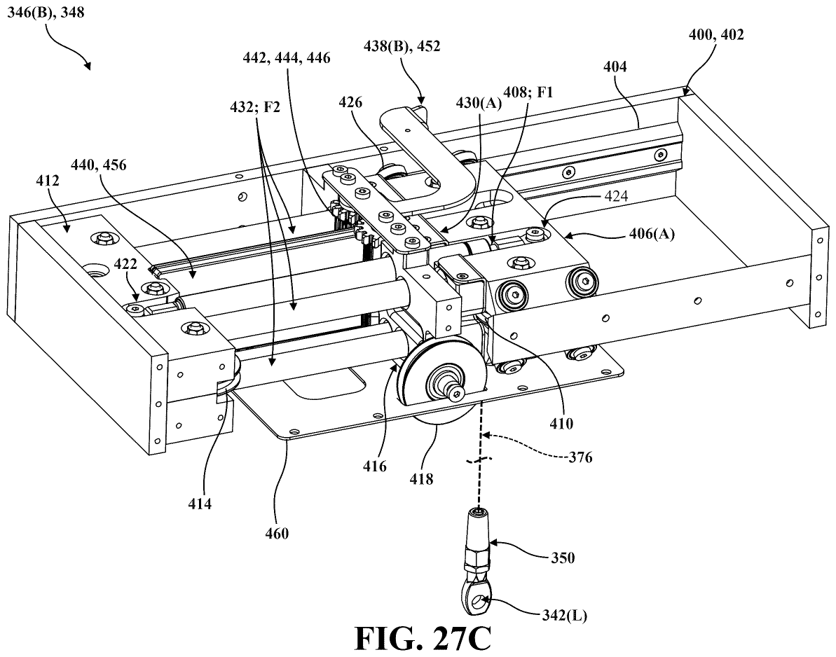

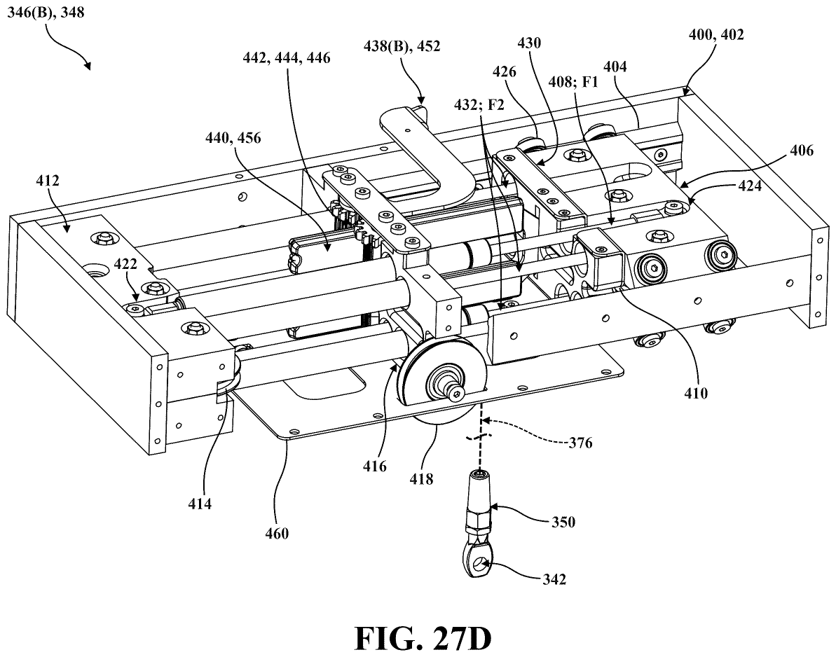

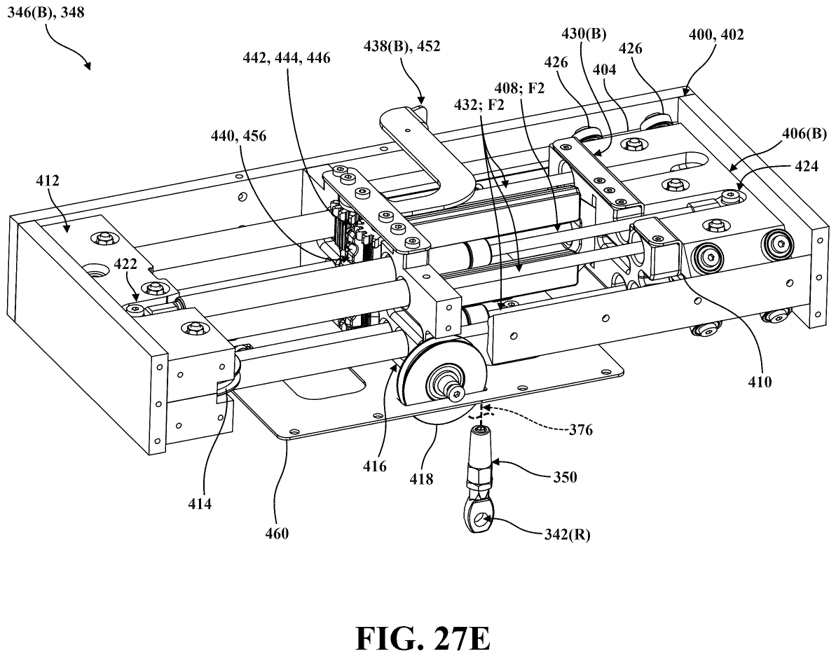

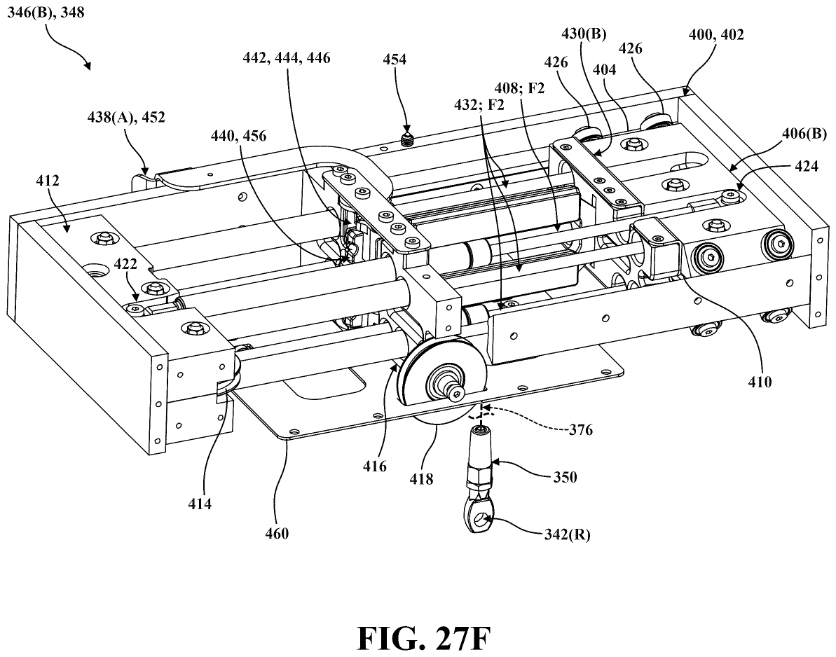

In order to facilitate operation in the second mode 346B, the loading subassembly 348 includes a driver interface 430 and a load actuator 432 interposed between the loading frame 400 and the driver interface 430 to urge the driver interface 430 into engagement with the carriage 406 during operation in the second mode 346B, with the lift actuator 408 and the load actuator 432 providing the second lifting force F2. In the illustrated version, the lift actuator 408 includes four gas springs 408 each having one end disposed within a corresponding frame bore 434 defined by the frame mount 412, and with the other end operatively attached to the driver interface 430. Here, the lift actuator gas springs 408 each extend through respective routing bores 436 defined in the routing mount 416. The driver interface 430 is supported for movement between a first interface position 430A (see FIGS. 27A-27C), and a second interface position 430B (see FIGS. 27E-27F) defined with the driver interface 430 engaging the carriage 406 at the second carriage position 406B. While the representative version illustrated throughout the drawings employs two gas springs for the lift actuator 408 and four gas springs for the load actuator 432, it will be appreciated that different quantities, configurations, and/or types of actuators 408, 432 may be employed, including without limitation extension springs, compression springs, different sizes or types of stored energy devices, and the like. Other configurations are contemplated.

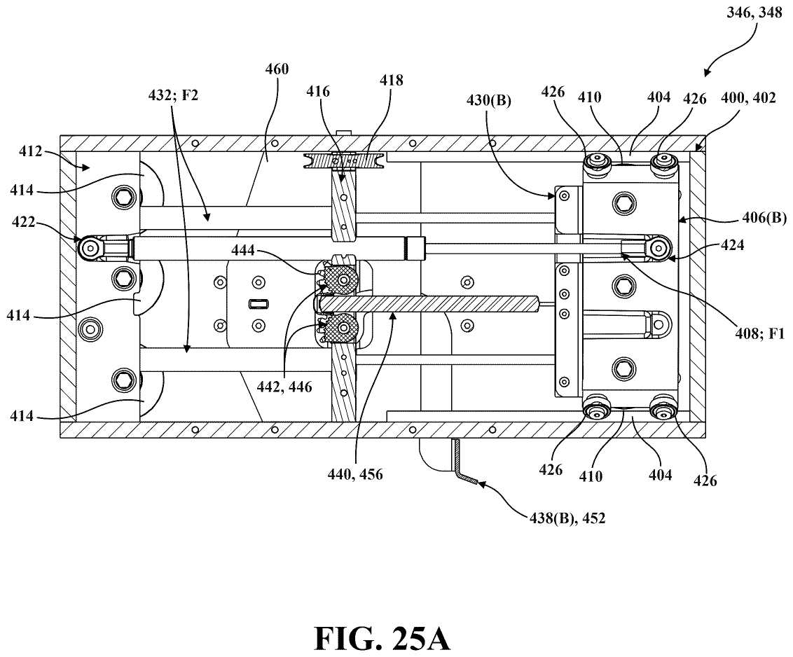

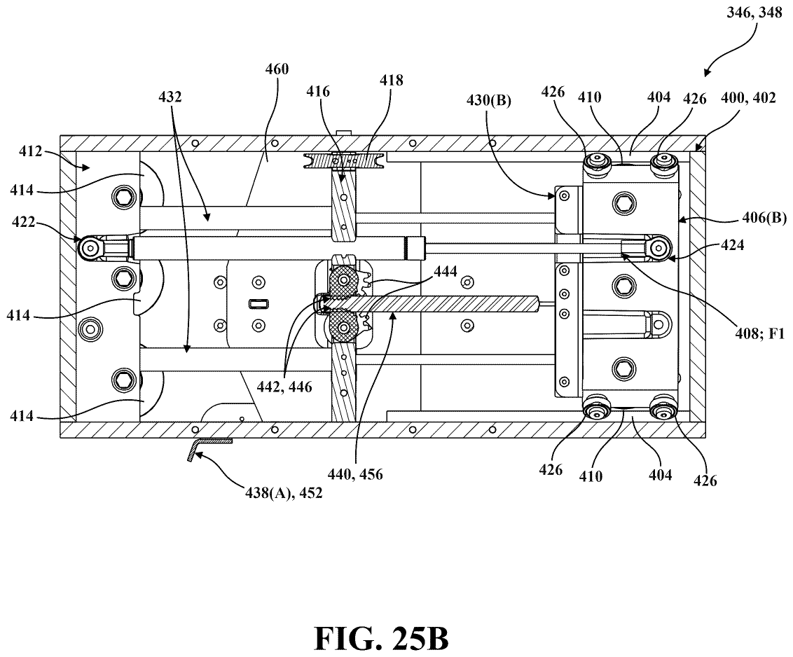

During operation in the first mode 346A, the driver interface 430 remains disposed in the first interface position 430A (see FIGS. 27A-27B) and force generated by the load actuator 432 is not transferred to the carriage 406. During operation in the second mode 346B, the driver interface 430 is able to move from the first interface position 430A (see FIG. 27C) to the second interface position 430B (see FIG. 27E), and force generated by the load actuator 432 is transferred to the carriage 406 and combines with force generated by the lift actuator 408 to provide the second lifting force F2. In order to change operation between the first mode 346A and the second mode 346B, the loading subassembly 348 includes a locking mechanism 438 operable between a retained mode 438A (see FIGS. 25B and 27A-27B) to inhibit movement of the driver interface 430 between the first interface position 430A and the second interface position 430B, and a released mode 438B (see FIGS. 25A and 27C-27E) to permit movement of the driver interface 430 between the first interface position 430A and the second interface position 430B. In some versions, operation in the first mode 346A is defined by operation of the locking mechanism 438 in the retained mode 438A with the driver interface 430 disposed in the first interface position 430A to permit movement of the carriage 406 between the first carriage position 406A and the second carriage position 406B with the first lifting force F1 provided by the lift actuator 408, and operation in the second mode 346B is defined by operation of the locking mechanism 438 in the released mode 438B with the driver interface 430 disposed in engagement with the carriage 406 to permit movement of the carriage 406 between the first carriage position 406A and the second carriage position 406B with the second lifting force F2 provided by the lift actuator 408 and the load actuator 432.

In some versions, movement of the receiver 342 towards the raised position 342R brings the carriage 406 out of engagement with the driver interface 430 retained in the first interface position 430A by the locking mechanism 438. Put differently, moving the receiver 342 from the lowered position 342L to the raised position 342R during operation in the first mode 346A with the patient transport apparatus 100 unloaded from the dock 344 moves the carriage 406 from the first carriage position 406A depicted in FIG. 27B to the second carriage position 406B depicted in FIG. 27A. In the illustrated version, as depicted in FIG. 27F, the locking mechanism 438 can also be used to inhibit movement of the carriage 406 out of the second carriage position 406B during operation in the second mode 346B to retain the receiver 342 in the raised position 342R. Thus, the locking mechanism 438 may also serve as a stage lock 370 in some versions.

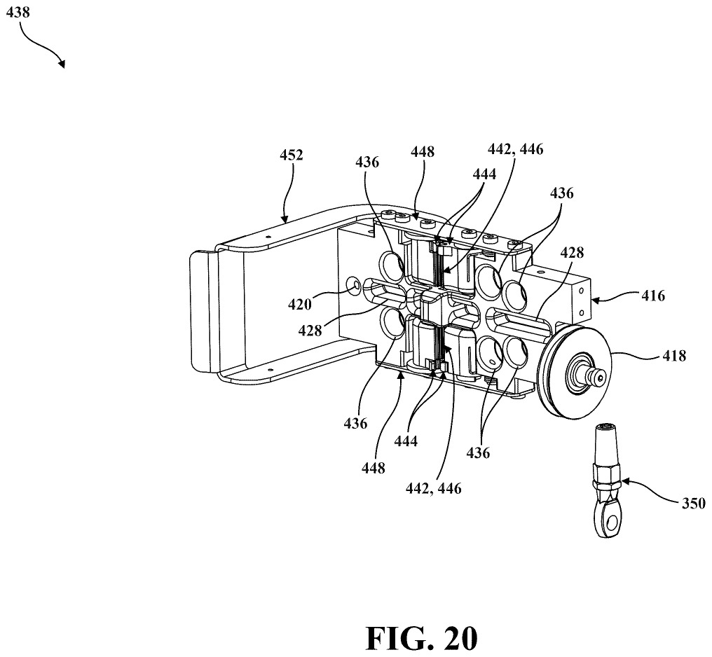

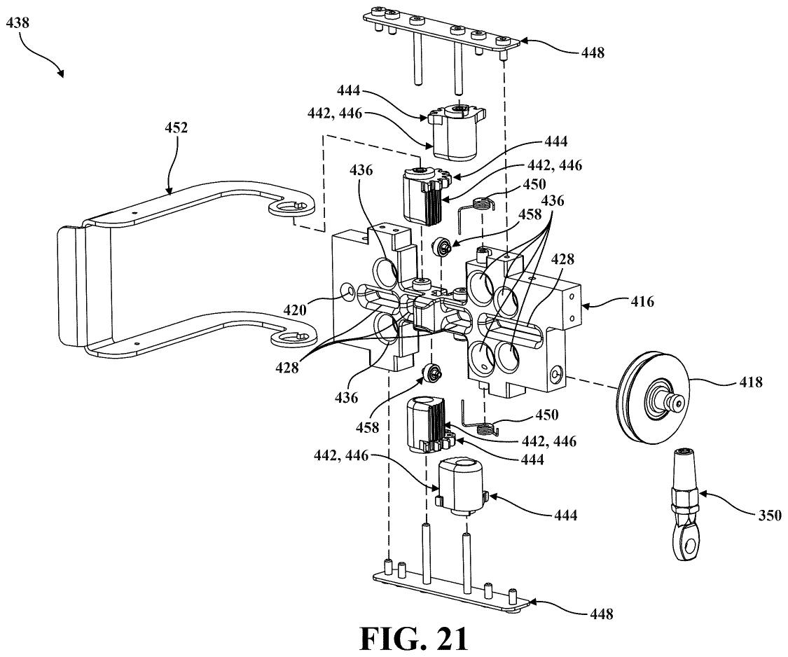

Referring now to FIGS. 19-21 and 25A-25B, the locking mechanism 438 generally includes a lock brace 440 operatively attached to the driver interface 430 for concurrent movement with the driver interface 430 between the first interface position 430A (see FIG. 27C) and the second interface position 430B (see FIG. 27E), and a lock catch 442 operatively attached to the loading frame 400 and arranged to engage the lock brace 440 during operation in the retained mode 438A (see FIG. 25B). As is best shown in FIG. 21, the lock catch 442 is realized by an arrangement of gears 444 having teeth 446 which grip into the lock brace 440 during operation in the retained mode 438A (see FIG. 25B) and which move out of engagement with the lock brace 440 during operation in the released mode 438B (see FIG. 25A). The gears 444 are supported for pivoting movement by fasteners (not shown in detail) coupled to plates 448 which, in turn, are coupled to the routing mount 416 in the illustrated version. The routing mount 416 also supports torsion springs 450 disposed between the gears 444 and the routing mount 416. A lock handle 452 is operatively attached to two of the gears 444 and is arranged for user engagement to change operation of the locking mechanism 438 between the retained mode 438A and the released mode 438B. In the illustrated version, a handle detent 454 is coupled to the loading frame 400 and is configured to engage the lock handle 452 to resist movement out of the released mode 438B.

As is best shown in FIG. 19, the lock brace 440 is realized as a generally U-shaped body with a pair of brace arms 456 formed of rubber, plastic, or another material suitable for engagement with the teeth 446 of the lock catch 442 during operation in the retained mode 438A (see FIG. 25B). In some versions, one or more brace support bearings 458 may be provided to abut portions of the brace arms 456 in different positions along their length as the driver interface 430 moves between the first interface position 430A and the second interface position 430B. In the illustrated version, the routing mount 416 supports two brace support bearings 458, and additional brace support bearings 458 are disposed on covers 460 attached to the loading frame 400 (see FIG. 19).

Several instances have been discussed in the foregoing description. However, the aspects discussed herein are not intended to be exhaustive or limit the disclosure to any particular form. Various modifications to these aspects will be readily apparent to those skilled in the art, and the generic principles defined herein may be applied to other aspects without departing from the scope of the disclosure. The terminology that has been used is intended to be in the nature of words of description rather than of limitation. Many modifications and variations are possible in light of the above teachings and the disclosure may be practiced otherwise than as specifically described.

The present disclosure also comprises the following clauses, with specific features laid out in dependent clauses, that may specifically be implemented as described in greater detail with reference to the configurations and drawings above.

### CLAUSES

I. A loading device for use in loading and unloading a patient transport apparatus from a transport vehicle, the patient transport apparatus including a support structure operable in a stowed configuration and having a track assembly with a movable belt for engaging stairs, the loading device comprising:
a mount configured for mounting to the transport vehicle;
a stage operatively attached to the mount;
a receiver arranged for translational movement relative to the stage between a lowered position and a raised position;
a dock operatively attached to the receiver for supporting the patient transport apparatus; and
an elevating mechanism operably coupled between the stage and the receiver, the elevating mechanism being operable between:
   a first mode defined with a first lifting force acting on the receiver to move the receiver from the lowered position towards the raised position, and
   a second mode defined with a second lifting force, greater than the first lifting force, acting on the receiver to move the receiver from the lowered position towards the raised position for moving the receiver and the patient transport apparatus loaded onto the dock into a secured configuration for transit with the transport vehicle.
II. The loading device of clause I, wherein the elevating mechanism includes:
   a loading subassembly operatively attached to one of the stage and the receiver; and
   an interface coupling operatively attached to the other of the stage and the receiver and disposed in force-translating communication with the loading subassembly.
III. The loading device of clause II, wherein the loading subassembly includes:
   a loading frame;
   a guide track coupled to the loading frame; and
   a carriage disposed in force-translating communication with the interface coupling and supported for sliding movement along the guide track between:
      a first carriage position corresponding to the lowered position of the receiver, and
      a second carriage position corresponding to the raised position of the receiver.
IV. The loading device of clause III, wherein movement of the receiver relative to the stage between the lowered position and the raised position occurs in a vertical direction; and
wherein movement of the carriage along the guide track between the first carriage position and the second carriage position occurs in a direction transverse to the vertical direction.
V. The loading device of any of clauses III-IV, wherein the loading subassembly includes a lift actuator interposed between the loading frame and the carriage, with the lift actuator providing the first lifting force.
VI. The loading device of clause V, wherein the lift actuator comprises one or more gas springs.
VII. The loading device of any of clauses V-VI, wherein the loading subassembly includes one or more carriage pullies operatively attached to the carriage for concurrent movement with the carriage between the first carriage position and the second carriage position; and
wherein the elevating mechanism includes:
   an end mount operatively attached to the loading frame, and
   a flexible tension element routed around the one or more carriage pullies and extending between the interface coupling and the end mount to translate force between the stage and the receiver.
VIII. The loading device of clause VII, wherein the loading subassembly includes one or more frame pullies operatively attached to the loading frame, with the flexible tension element routed around the one or more frame pullies.
IX. The loading device of clause VIII, wherein movement of the carriage from the first carriage position towards the second carriage position moves the one or more carriage pullies away from the one or more frame pullies.
X. The loading device of any of clauses V-IX, wherein the loading subassembly includes a driver interface and a load actuator interposed between the loading frame and the driver interface to urge the driver interface into engagement with the carriage during operation in the second mode, with the lift actuator and the load actuator providing the second lifting force.
XI. The loading device of clause X, wherein the load actuator comprises one or more gas springs.
XII. The loading device of any of clauses X-XI, wherein the driver interface is supported for movement between:
   a first interface position, and
   a second interface position defined with the driver interface engaging the carriage in the second carriage position.
XIII. The loading device of clause XII, wherein the loading subassembly includes a locking mechanism operable between:
   a retained mode to inhibit movement of the driver interface between the first interface position and the second interface position, and
   a released mode to permit movement of the driver interface between the first interface position and the second interface position.
XIV. The loading device of clause XIII, wherein the locking mechanism includes:
   a lock brace operatively attached to the driver interface for concurrent movement between the first interface position and the second interface position; and
   a lock catch operatively attached to the loading frame and arranged to engage the lock brace during operation in the retained mode.
XV. The loading device of any of clauses XIII-XIV, wherein the first mode is further defined by operation of the locking mechanism in the retained mode with the driver interface disposed in the first interface position to permit movement of the carriage between the first carriage position and the second carriage position with the first lifting force provided by the lift actuator; and

wherein operation in the second mode is further defined by operation of the locking mechanism in the released mode with the driver interface disposed in engagement with the carriage to permit movement of the carriage between the first carriage position and the second carriage position with the first lifting force provided by the lift actuator and the load actuator.
XVI. The loading device of any of clauses XIII-XV, wherein movement of the receiver towards the raised position brings the carriage out of engagement with the driver interface retained in the first interface position by the locking mechanism.
XVII. The loading device of any of clauses I-XVI, wherein the elevating mechanism includes:
   a guide track operatively attached to the stage;
   a carriage supported for sliding movement along the guide track between:
      a first carriage position corresponding to the lowered position of the receiver, and
      a second carriage position corresponding to the raised position of the receiver; and
   a lift actuator interposed between the stage and the carriage, with the lift actuator providing the first lifting force. XVIII. The loading device of clause XVII, wherein the elevating mechanism includes:
   one or more carriage pullies operatively attached to the carriage for concurrent movement with the carriage between the first carriage position and the second carriage position;
   an end mount operatively attached to the receiver; and
   a flexible tension element routed around the one or more carriage pullies and extending between the stage and the end mount to translate force between the stage and the receiver.
XIX. The loading device of clause XVIII, wherein the elevating mechanism includes one or more frame pullies operatively attached to the stage, with the flexible tension element routed around the one or more frame pullies.
XX. The loading device of clause XIX, wherein movement of the carriage from the first carriage position towards the second carriage position moves the one or more carriage pullies away from the one or more frame pullies.
XXI. The loading device of any of clauses XVII-XX, wherein the elevating mechanism includes:
   a driver interface; and
   a load actuator interposed between the stage and the driver interface to urge the driver interface into engagement with the carriage during operation in the second mode, with the lift actuator and the load actuator providing the second lifting force.
XXII. The loading device of clause XXI, wherein the driver interface is supported for movement between:
   a first interface position, and
   a second interface position defined with the driver interface engaging the carriage in the second carriage position.
XXIII. The loading device of clause XXII, wherein the elevating mechanism includes a locking mechanism operable between:
   a retained mode to inhibit movement of the driver interface between the first interface position and the second interface position, and
   a released mode to permit movement of the driver interface between the first interface position and the second interface position.
XXIV. The loading device of clause XXIII, wherein the locking mechanism includes:
   a lock brace operatively attached to the driver interface for concurrent movement between the first interface position and the second interface position; and
   a lock catch operatively attached to the stage and arranged to engage the lock brace during operation in the retained mode.
XXV. The loading device of any of clauses XXIII-XXIV, wherein the first mode is further defined by operation of the locking mechanism in the retained mode with the driver interface disposed in the first interface position to permit movement of the carriage between the first carriage position and the second carriage position with the first lifting force provided by the lift actuator; and
wherein operation in the second mode is further defined by operation of the locking mechanism in the released mode with the driver interface disposed in engagement with the carriage to permit movement of the carriage between the first carriage position and the second carriage position with the first lifting force provided by the lift actuator and the load actuator.
XXVI. The loading device of any of clauses XXIII-XXV, wherein movement of the receiver towards the raised position brings the carriage out of engagement with the driver interface retained in the first interface position by the locking mechanism.
XXVII. The loading device of any of clauses I-XXVI, comprising a limiter interposed between the stage and the receiver to inhibit movement of the receiver relative to the stage in a plurality of degrees of freedom.
XXVIII. The loading device of clause XXVII, wherein the limiter is configured to inhibit lateral and longitudinal movement of the receiver relative to the stage.
XXIX. The loading device of any of clauses XXVII-XXVIII, wherein the limiter includes a linear slide assembly supporting the receiver for sliding movement relative to the stage between the lowered position and the raised position.
XXX. The loading device of clause XXIX, comprising a stage lock interposed between the stage and the receiver to selectively inhibit movement of the receiver relative to the stage between the lowered position and the raised position.
XXXI. The loading device of clause XXX, wherein the stage lock is configured to maintain the receiver in the raised position.
XXXII. The loading device of any of clauses I-XXXI, comprising:
   a second stage operatively attached to the mount;
   a second receiver supporting the stage and arranged for translational movement relative to the second stage between a retracted position and an extended position; and
   a second limiter interposed between the second stage and the second receiver to inhibit movement of the second receiver relative to the second stage in a second plurality of degrees of freedom.
XXXIII. The loading device of clause XXXII, comprising:
   a stage lock interposed between the stage and the receiver to selectively inhibit movement of the receiver relative to the stage between the lowered position and the raised position; and
   a second stage lock interposed between the second stage and the second receiver to selectively inhibit movement of the second receiver relative to the second stage between the retracted position and the extended position.
XXXIV. The loading device of clause XXXIII, wherein the stage lock is configured to maintain the receiver in the raised position; and
wherein the second stage lock is configured to maintain the second receiver in the retracted position.
XXXV. The loading device of any of clauses XXXII-XXXIV, wherein the limiter is configured to inhibit lateral and longitudinal movement of the receiver relative to the stage; and
wherein the second limiter is configured to inhibit vertical and longitudinal movement of the second receiver relative to the second stage.
XXXVI. The loading device of any of clauses XXXII-XXXV, wherein the limiter includes a linear slide assembly supporting the receiver for sliding movement relative to the stage between the lowered position and the raised position; and
wherein the second limiter includes a second linear slide assembly supporting the second receiver for sliding movement relative to the second stage between the retracted position and the extended position.
XXXVII. The loading device of any of clauses XXXII-XXXVI, wherein movement of the receiver relative to the stage between the lowered position and the raised position occurs in a vertical direction; and
wherein movement of the second receiver relative to the second stage between the retracted position and the extended position occurs in a direction transverse to the vertical direction.
XXXVIII. The loading device of any of clauses XXXII-XXXVII, wherein the second stage is coupled to the mount and supports the second receiver for concurrent movement with the stage relative to the mount between the retracted position and the extended position.
XXXIX. The loading device of any of clauses XXXII-XXXVIII, wherein the secured configuration is defined with the receiver arranged in the raised position and with the second receiver arranged in the retracted position to facilitate transit of the transport vehicle.
XL. The loading device of clause XXXIX, wherein the receiver is supported for selective movement relative to the transport vehicle between:
   the secured configuration,
   an intermediate configuration defined with the receiver arranged in the raised position and with the second receiver arranged in the extended position, and
   an access configuration defined with the receiver arranged in the lowered position and with the second receiver arranged in the extended position for loading and unloading the patient transport apparatus.
XLI. A system for use with a transport vehicle, the system comprising:
a patient transport apparatus including:
   a support structure having a seat section and being movable between a stowed configuration and one or more patient transport configurations, and
   a track assembly operatively attached to the support structure and including a movable belt for engaging stairs in one of the one or more patient transport configurations; and
a loading device configured to engage the patient transport apparatus in the stowed configuration for loading and unloading from the transport vehicle, the loading device including:
   a mount configured for mounting to the transport vehicle,
   a stage operatively attached to the mount,
   a receiver arranged for translational movement relative to the stage between a lowered position and a raised position,
   a dock operatively attached to the receiver for supporting the patient transport apparatus, and
   an elevating mechanism operably coupled between the stage and the receiver, the elevating mechanism being operable between:
      a first mode defined with a first lifting force acting on the receiver to move the receiver from the lowered position towards the raised position, and
      a second mode defined with a second lifting force, greater than the first lifting force, acting on the receiver to move the receiver from the lowered position towards the raised position for moving the receiver and the patient transport apparatus loaded onto the dock into a secured configuration for transit with the transport vehicle.
XLII. The system of clause XLI, wherein the elevating mechanism of the loading device includes:
   a loading subassembly operatively attached to one of the stage and the receiver; and
   an interface coupling operatively attached to the other of the stage and the receiver and disposed in force-translating communication with the loading subassembly.
XLIII. The system of clause XLII, wherein the loading subassembly includes:
   a loading frame;
   a guide track coupled to the loading frame; and
   a carriage disposed in force-translating communication with the interface coupling and supported for sliding movement along the guide track between:
      a first carriage position corresponding to the lowered position of the receiver, and
      a second carriage position corresponding to the raised position of the receiver.
XLIV. The system of clause XLIII, wherein movement of the receiver relative to the stage between the lowered position and the raised position occurs in a vertical direction; and
wherein movement of the carriage along the guide track between the first carriage position and the second carriage position occurs in a direction transverse to the vertical direction.
XLV. The system of any of clauses XLIII-XLIV, wherein the loading subassembly includes a lift actuator interposed between the loading frame and the carriage, with the lift actuator providing the first lifting force.
XLVI. The system of clause XLV, wherein the lift actuator comprises one or more gas springs.
XLVII. The system of any of clauses XLV-XLVI, wherein the loading subassembly includes one or more carriage pullies operatively attached to the carriage for concurrent movement with the carriage between the first carriage position and the second carriage position; and
wherein the elevating mechanism includes:
   an end mount operatively attached to the loading frame, and
   a flexible tension element routed around the one or more carriage pullies and extending between the interface coupling and the end mount to translate force between the stage and the receiver.
XLVIII. The system of clause XLVII, wherein the loading subassembly includes one or more frame pullies operatively attached to the loading frame, with the flexible tension element routed around the one or more frame pullies.
XLIX. The system of clause XLVIII, wherein movement of the carriage from the first carriage position towards the second carriage position moves the one or more carriage pullies away from the one or more frame pullies.
L. The system of any of clauses XLV-XLIX, wherein the loading subassembly includes a driver interface and a load actuator interposed between the loading frame and the driver interface to urge the driver interface into engagement with the carriage during operation in the second mode, with the lift actuator and the load actuator providing the second lifting force.
LI. The system of clause L, wherein the load actuator comprises one or more gas springs.
LII. The system of any of clauses L-LI, wherein the driver interface is supported for movement between:
   a first interface position, and
   a second interface position defined with the driver interface engaging the carriage in the second carriage position.
LIII. The system of clause LII, wherein the loading subassembly includes a locking mechanism operable between:
   a retained mode to inhibit movement of the driver interface between the first interface position and the second interface position, and
   a released mode to permit movement of the driver interface between the first interface position and the second interface position.
LIV. The system of clause LIII, wherein the locking mechanism includes:
   a lock brace operatively attached to the driver interface for concurrent movement between the first interface position and the second interface position; and
   a lock catch operatively attached to the loading frame and arranged to engage the lock brace during operation in the retained mode.
LV. The system of any of clauses LIII-LIV, wherein the first mode is further defined by operation of the locking mechanism in the retained mode with the driver interface disposed in the first interface position to permit movement of the carriage between the first carriage position and the second carriage position with the first lifting force provided by the lift actuator; and
wherein operation in the second mode is further defined by operation of the locking mechanism in the released mode with the driver interface disposed in engagement with the carriage to permit movement of the carriage between the first carriage position and the second carriage position with the first lifting force provided by the lift actuator and the load actuator.
LVI. The system of any of clauses LIII-LV, wherein movement of the receiver towards the raised position brings the carriage out of engagement with the driver interface retained in the first interface position by the locking mechanism.
LVII. The system of any of clauses XLI-LVI, wherein the elevating mechanism includes:
   a guide track operatively attached to the stage;
   a carriage supported for sliding movement along the guide track between:
      a first carriage position corresponding to the lowered position of the receiver, and
      a second carriage position corresponding to the raised position of the receiver; and
   a lift actuator interposed between the stage and the carriage, with the lift actuator providing the first lifting force.
LVIII. The system of clause LVII, wherein the elevating mechanism includes:
   one or more carriage pullies operatively attached to the carriage for concurrent movement with the carriage between the first carriage position and the second carriage position;
   an end mount operatively attached to the receiver; and
   a flexible tension element routed around the one or more carriage pullies and extending between the stage and the end mount to translate force between the stage and the receiver.
LIX. The system of clause LVIII, wherein the elevating mechanism includes one or more frame pullies operatively attached to the stage, with the flexible tension element routed around the one or more frame pullies.
LX. The system of clause LIX, wherein movement of the carriage from the first carriage position towards the second carriage position moves the one or more carriage pullies away from the one or more frame pullies.
LXI. The system of any of clauses LVII-LX, wherein the elevating mechanism includes:
   a driver interface; and
   a load actuator interposed between the stage and the driver interface to urge the driver interface into engagement with the carriage during operation in the second mode, with the lift actuator and the load actuator providing the second lifting force.
LXII. The system of clause LXI, wherein the driver interface is supported for movement between:
   a first interface position, and
   a second interface position defined with the driver interface engaging the carriage in the second carriage position.
LXIII. The system of clause LXII, wherein the elevating mechanism includes a locking mechanism operable between:
   a retained mode to inhibit movement of the driver interface between the first interface position and the second interface position, and
   a released mode to permit movement of the driver interface between the first interface position and the second interface position.
LXIV. The system of clause LXIII, wherein the locking mechanism includes:
   a lock brace operatively attached to the driver interface for concurrent movement between the first interface position and the second interface position; and
   a lock catch operatively attached to the stage and arranged to engage the lock brace during operation in the retained mode.
LXV. The system of any of clauses LXIII-LXIV, wherein the first mode is further defined by operation of the locking mechanism in the retained mode with the driver interface disposed in the first interface position to permit movement of the carriage between the first carriage position and the second carriage position with the first lifting force provided by the lift actuator; and
wherein operation in the second mode is further defined by operation of the locking mechanism in the released mode with the driver interface disposed in engagement with the carriage to permit movement of the carriage between the first carriage position and the second carriage position with the first lifting force provided by the lift actuator and the load actuator.
LXVI. The system of any of clauses LXIII-LXV, wherein movement of the receiver towards the raised position brings the carriage out of engagement with the driver interface retained in the first interface position by the locking mechanism.
LXVII. The system of any of clauses XLI-LXVI, wherein the loading device includes a limiter interposed between the stage and the receiver to inhibit movement of the receiver relative to the stage in a plurality of degrees of freedom.
LXVIII. The system of clause LXVII, wherein the limiter is configured to inhibit lateral and longitudinal movement of the receiver relative to the stage.
LXIX. The system of any of clauses LXVII-LXVIII, wherein the limiter includes a linear slide assembly supporting the receiver for sliding movement relative to the stage between the lowered position and the raised position.
LXX. The system of clause LXIX, wherein the loading device includes a stage lock interposed between the stage and the receiver to selectively inhibit movement of the receiver relative to the stage between the lowered position and the raised position.
LXXI. The system of clause LXX, wherein the stage lock is configured to maintain the receiver in the raised position.
LXXII. The system of any of clauses XLI-LXXI, wherein the loading device includes:
   a second stage operatively attached to the mount;
   a second receiver supporting the stage and arranged for translational movement relative to the second stage between a retracted position and an extended position; and
   a second limiter interposed between the second stage and the second receiver to inhibit movement of the second receiver relative to the second stage in a second plurality of degrees of freedom.
LXXIII. The system of clause LXXII, wherein the loading device includes:
   a stage lock interposed between the stage and the receiver to selectively inhibit movement of the receiver relative to the stage between the lowered position and the raised position; and
   a second stage lock interposed between the second stage and the second receiver to selectively inhibit movement of the second receiver relative to the second stage between the retracted position and the extended position.
LXXIV. The system of clause LXXIII, wherein the stage lock is configured to maintain the receiver in the raised position; and
wherein the second stage lock is configured to maintain the second receiver in the retracted position.
LXXV. The system of any of clauses LXXII-LXXIV, wherein the limiter is configured to inhibit lateral and longitudinal movement of the receiver relative to the stage; and
wherein the second limiter is configured to inhibit vertical and longitudinal movement of the second receiver relative to the second stage.
LXXVI. The system of any of clauses LXXII-LXXV, wherein the limiter includes a linear slide assembly supporting the receiver for sliding movement relative to the stage between the lowered position and the raised position; and
wherein the second limiter includes a second linear slide assembly supporting the second receiver for sliding movement relative to the second stage between the retracted position and the extended position.
LXXVII. The system of any of clauses LXXII-LXXVI, wherein movement of the receiver relative to the stage between the lowered position and the raised position occurs in a vertical direction; and
wherein movement of the second receiver relative to the second stage between the retracted position and the extended position occurs in a direction transverse to the vertical direction.
LXXVIII. The system of any of clauses LXXII-LXXVII, wherein the second stage is coupled to the mount and supports the second receiver for concurrent movement with the stage relative to the mount between the retracted position and the extended position.
LXXIX. The system of any of clauses LXXII-LXXVIII, wherein the secured configuration is defined with the receiver arranged in the raised position and with the second receiver arranged in the retracted position to facilitate transit of the transport vehicle.
LXXX. The system of clause LXXIX, wherein the receiver is supported for selective movement relative to the transport vehicle between:
   the secured configuration,
   an intermediate configuration defined with the receiver arranged in the raised position and with the second receiver arranged in the extended position, and
   an access configuration defined with the receiver arranged in the lowered position and with the second receiver arranged in the extended position for loading and unloading the patient transport apparatus.
LXXXI. The system of clause XLI, wherein the patient transport apparatus includes:
   a motor coupled to the support structure and operably coupled to the track assembly for operating the movable belt; and
   a battery coupled to the support structure and in electrical communication with the motor.
LXXXII. The system of any of clauses XLI-LXXX, wherein the track assembly of the patient transport apparatus is arranged for selective operation between:
   a retracted position; and
   a deployed position where the track assembly is arranged to engage stairs.
LXXXIII. The system of clause LXXXII, wherein the track assembly of the patient transport apparatus is arranged in the retracted position during operation in the stowed configuration.
LXXXIV. The system of any of clauses LXXXII-LXXXIII, wherein the one or more patient transport configurations include:
   a chair configuration where the track assembly is arranged in the retracted position for supporting the patient transport apparatus for movement along floor surfaces; and
   a stair configuration where the track assembly is arranged in the deployed position for supporting the patient transport apparatus for movement along stairs.

What is claimed is:

1. A loading device for use in loading and unloading a patient transport apparatus from a transport vehicle, the patient transport apparatus including a support structure operable in a stowed configuration and having a track assembly with a movable belt for engaging stairs, the loading device comprising:
a mount configured for mounting to the transport vehicle;
a stage operatively attached to the mount;
a receiver arranged for translational movement relative to the stage between a lowered position and a raised position;
a dock operatively attached to the receiver for supporting the patient transport apparatus; and
an elevating mechanism operably coupled between the stage and the receiver, the elevating mechanism being operable between:
a first mode defined with a first lifting force acting on the receiver to move the receiver from the lowered position towards the raised position, and
a second mode defined with a second lifting force, greater than the first lifting force, acting on the receiver to move the receiver from the lowered position towards the raised position for moving the receiver and the patient transport apparatus loaded onto the dock into a secured configuration for transit with the transport vehicle.

2. The loading device of claim 1, wherein the elevating mechanism includes:
a loading subassembly operatively attached to one of the stage and the receiver; and
an interface coupling operatively attached to the other of the stage and the receiver and disposed in force-translating communication with the loading subassembly; and
wherein the loading subassembly includes:
a loading frame;
a guide track coupled to the loading frame; and
a carriage disposed in force-translating communication with the interface coupling and supported for sliding movement along the guide track between:
a first carriage position corresponding to the lowered position of the receiver, and
a second carriage position corresponding to the raised position of the receiver.

3. The loading device of claim 2, wherein movement of the receiver relative to the stage between the lowered position and the raised position occurs in a vertical direction; and
wherein movement of the carriage along the guide track between the first carriage position and the second carriage position occurs in a direction transverse to the vertical direction.

4. The loading device of claim 2, wherein the loading subassembly includes a lift actuator interposed between the loading frame and the carriage, with the lift actuator providing the first lifting force;
wherein the loading subassembly includes one or more carriage pullies operatively attached to the carriage for concurrent movement with the carriage between the first carriage position and the second carriage position; and
wherein the elevating mechanism includes:
an end mount operatively attached to the loading frame, and
a flexible tension element routed around the one or more carriage pullies and extending between the interface coupling and the end mount to translate force between the stage and the receiver.

5. The loading device of claim 4, wherein the loading subassembly includes one or more frame pullies operatively attached to the loading frame, with the flexible tension element routed around the one or more frame pullies; and
wherein movement of the carriage from the first carriage position towards the second carriage position moves the one or more carriage pullies away from the one or more frame pullies.

6. The loading device of claim 2, wherein the loading subassembly includes a lift actuator interposed between the loading frame and the carriage, with the lift actuator providing the first lifting force;
wherein the loading subassembly includes a driver interface and a load actuator interposed between the loading frame and the driver interface to urge the driver interface into engagement with the carriage during operation in the second mode, with the lift actuator and the load actuator providing the second lifting force;
wherein the driver interface is supported for movement between:
a first interface position, and
a second interface position defined with the driver interface engaging the carriage in the second carriage position; and
wherein the loading subassembly includes a locking mechanism operable between:
a retained mode to inhibit movement of the driver interface between the first interface position and the second interface position, and
a released mode to permit movement of the driver interface between the first interface position and the second interface position.

7. The loading device of claim 6, wherein the locking mechanism includes:
a lock brace operatively attached to the driver interface for concurrent movement between the first interface position and the second interface position; and
a lock catch operatively attached to the loading frame and arranged to engage the lock brace during operation in the retained mode.

8. The loading device of claim 6, wherein the first mode is further defined by operation of the locking mechanism in the retained mode with the driver interface disposed in the first interface position to permit movement of the carriage between the first carriage position and the second carriage position with the first lifting force provided by the lift actuator; and
wherein operation in the second mode is further defined by operation of the locking mechanism in the released mode with the driver interface disposed in engagement with the carriage to permit movement of the carriage between the first carriage position and the second carriage position with the first lifting force provided by the lift actuator and the load actuator.

9. The loading device of claim 1, wherein the elevating mechanism includes:
a guide track operatively attached to the stage;
a carriage supported for sliding movement along the guide track between:
a first carriage position corresponding to the lowered position of the receiver, and
a second carriage position corresponding to the raised position of the receiver; and
a lift actuator interposed between the stage and the carriage, with the lift actuator providing the first lifting force.

10. The loading device of claim 9, wherein the elevating mechanism includes:
one or more carriage pullies operatively attached to the carriage for concurrent movement with the carriage between the first carriage position and the second carriage position;
an end mount operatively attached to the receiver; and
a flexible tension element routed around the one or more carriage pullies and extending between the stage and the end mount to translate force between the stage and the receiver;
wherein the elevating mechanism includes one or more frame pullies operatively attached to the stage, with the flexible tension element routed around the one or more frame pullies; and
wherein movement of the carriage from the first carriage position towards the second carriage position moves the one or more carriage pullies away from the one or more frame pullies.

11. The loading device of claim 9, wherein the elevating mechanism includes:
a driver interface; and
a load actuator interposed between the stage and the driver interface to urge the driver interface into engagement with the carriage during operation in the second mode, with the lift actuator and the load actuator providing the second lifting force;
wherein the driver interface is supported for movement between:
a first interface position, and
a second interface position defined with the driver interface engaging the carriage in the second carriage position; and
wherein the elevating mechanism includes a locking mechanism operable between:
a retained mode to inhibit movement of the driver interface between the first interface position and the second interface position, and
a released mode to permit movement of the driver interface between the first interface position and the second interface position.

12. The loading device of claim 11, wherein the locking mechanism includes:
a lock brace operatively attached to the driver interface for concurrent movement between the first interface position and the second interface position; and
a lock catch operatively attached to the stage and arranged to engage the lock brace during operation in the retained mode.

13. The loading device of claim 11, wherein the first mode is further defined by operation of the locking mechanism in the retained mode with the driver interface disposed in the first interface position to permit movement of the carriage between the first carriage position and the second carriage position with the first lifting force provided by the lift actuator; and
wherein operation in the second mode is further defined by operation of the locking mechanism in the released mode with the driver interface disposed in engagement with the carriage to permit movement of the carriage between the first carriage position and the second carriage position with the first lifting force provided by the lift actuator and the load actuator.

14. The loading device of claim 11, wherein movement of the receiver towards the raised position brings the carriage out of engagement with the driver interface retained in the first interface position by the locking mechanism.

15. The loading device of claim 1, comprising a limiter interposed between the stage and the receiver to inhibit movement of the receiver relative to the stage in a plurality of degrees of freedom.

16. The loading device of claim 15, wherein the limiter is configured to inhibit lateral and longitudinal movement of the receiver relative to the stage.

17. The loading device of claim 15, wherein the limiter includes a linear slide assembly supporting the receiver for sliding movement relative to the stage between the lowered position and the raised position; and
further comprising a stage lock interposed between the stage and the receiver to selectively inhibit movement of the receiver relative to the stage between the lowered position and the raised position, wherein the stage lock is configured to maintain the receiver in the raised position.

18. The loading device of claim 1, comprising:
a second stage operatively attached to the mount;
a second receiver supporting the stage and arranged for translational movement relative to the second stage between a retracted position and an extended position; and
a second limiter interposed between the second stage and the second receiver to inhibit movement of the second receiver relative to the second stage in a second plurality of degrees of freedom.

19. The loading device of claim 18, comprising:
a stage lock interposed between the stage and the receiver to selectively inhibit movement of the receiver relative to the stage between the lowered position and the raised position, wherein the stage lock is configured to maintain the receiver in the raised position; and
a second stage lock interposed between the second stage and the second receiver to selectively inhibit movement of the second receiver relative to the second stage between the retracted position and the extended position, wherein the second stage lock is configured to maintain the second receiver in the retracted position.

20. The loading device of claim 18, wherein the secured configuration is defined with the receiver arranged in the raised position and with the second receiver arranged in the retracted position to facilitate transit of the transport vehicle; and
wherein the receiver is supported for selective movement relative to the transport vehicle between:
the secured configuration,
an intermediate configuration defined with the receiver arranged in the raised position and with the second receiver arranged in the extended position, and
an access configuration defined with the receiver arranged in the lowered position and with the second receiver arranged in the extended position for loading and unloading the patient transport apparatus.
